(19) United States
(12) Patent Application Publication
(10) Pub. No.: US 2012/0176329 A1
(43) Pub. Date: Jul. 12, 2012

(54) TERMINAL HAVING TOUCH SCREEN AND CHARACTER INPUT METHOD ACCORDING TO TOUCH EVENT THEREIN

(75) Inventor: Bong Jae Rhee, Suwon-si (KR)

(73) Assignee: SAMSUNG ELECTRONICS CO., LTD., Suwon-si (KR)

(21) Appl. No.: 13/346,713

(22) Filed: Jan. 9, 2012

(30) Foreign Application Priority Data
Jan. 11, 2011 (KR) 10-2011-0002756

(51) Int. Cl. G06F 3/041

(52) U.S. Cl. 345/173

(57) ABSTRACT

A portable terminal includes a touch screen capable of performing a character input method according to a touch event. The character input method in a terminal having a touch screen, includes: checking and displaying a character mapped to a sensed region of a first touch event when the first touch event is sensed in a character input mode, and determining whether the first touch event is released; determining whether the first touch event is moved when the first touch event is not released; and confirming a moving direction of the first touch event and adding a vowel to display a character when the first touch event is moved.

### CROSS-REFERENCE TO RELATED APPLICATION(S) AND CLAIM OF PRIORITY

The present application is related to and claims the benefit of priority under 35 U.S.C. §119(a) of a Korean patent application filed in the Korean Intellectual Property Office on Jan. 11, 2011 and assigned Serial No. 10-2011-0002756, the entire disclosure of which is hereby incorporated by reference.

### TECHNICAL FIELD OF THE INVENTION

The present disclosure relates to a terminal having a touch screen and a character input method according to a touch event therein, and more particularly, to a terminal having a touch screen and a method for inputting characters in the terminal according to a moving direction of a touch event.

### BACKGROUND OF THE INVENTION

In general, a touch screen is a device for performing an input function in which a touch sensor is attached to a display unit. The touch screen is adhered to a small terminal having a small size. In particular, the reason to use a touch screen as an input device for inputting characters or selecting menus in a small terminal is that there is no space to separately arrange an input unit at a small terminal and for convenient input.

There is a method for displaying a virtual key pad of a Qwerty type or a virtual key pad of a 3*4 type such a key board of a computer to input characters as a method for inputting characters through a touch screen. In the virtual key pad of a Qwerty type or a virtual key pad of a 3*4 type, characters are allotted to respective keys constituting a key pad.

However, the size of a touch screen included in a terminal may be restricted according to the size of the terminal in which a touch sensor is adhered to a display unit. Due to this, when a virtual key pad is displayed on a touch screen of the terminal to input characters, a key region to which characters are allotted becomes small. Accordingly, it is difficult for the user to exactly touch a region on a touch screen to which desired characters are allotted.

### SUMMARY OF THE INVENTION

To address the above-discussed deficiencies of the prior art, it is a primary object to provide a terminal having a touch screen and a method for inputting characters in the terminal according to a touch event.

In accordance with an aspect of the present disclosure, a character input method in a terminal having a touch screen, including: checking and displaying a character mapped to a sensed region of a first touch event when the first touch event is sensed in a character input mode, and determining whether the first touch event is released; determining whether the first touch event is moved when the first touch event is not released; and confirming a moving direction of the first touch event and adding a vowel to display a character when the first touch event is moved.

In accordance with another aspect of the present disclosure, a character input terminal comprising; a touch screen including a touch sensor that can sense a touch event and a display unit that can display a vowel according to a moving direction of the touch event; a memory that can store vowel mapping information by directions to display the vowel according to the moving direction of the touch event; and a controller that can confirm and display a character mapped to a sensed region of a first touch event when the first touch event is sensed through the touch screen in a character input mode, determine whether the first touch event is moved when the first touch event is not released, confirm a moving direction of the first touch event when the touch event is moved, and add a vowel according to the moving direction to the vowel mapping information by directions to display the added vowel mapping information on the display unit.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of a terminal according to an exemplary embodiment of the present disclosure;

FIG. 2 illustrates a moving direction of a touch event according to an embodiment of the present disclosure;

FIG. 3 illustrates vowels input according to a touch event based on a first cardinal vowel according to a first embodiment of the present disclosure;

FIG. 4 illustrates vowels input according to a moving direction of one touch event based on a second cardinal vowel according to a first embodiment of the present disclosure;

FIG. 5 illustrates vowels input according to a moving direction of two touch events based on a second cardinal vowel according to a first embodiment of the present disclosure;

FIG. 6 illustrates vowels input according to a moving direction of two touch events based on a second cardinal vowel according to a first embodiment of the present disclosure;

FIGS. 7A-7D illustrate a procedure that is changed according to a moving direction of a touch event by vowels according to a first embodiment of the present disclosure;

FIGS. 8A-8B illustrate a method for inputting a vowel ‘-(eu)’ according to a moving direction of one touch event according to a second embodiment of the present disclosure;

FIGS. 9A-9B illustrate a method for inputting a vowel ‘|(i)’ according to a moving direction of one touch event according to a second embodiment of the present disclosure;

FIGS. 10A-10B illustrate a method for inputting a vowel ‘ [symbol] (ya)’ according to a moving direction of one touch event according to a second embodiment of the present disclosure;

FIGS. 11A-11B illustrate a method for inputting a vowel ‘ [symbol] (yeo)’ according to a moving direction of one touch event according to a second embodiment of the present disclosure;

FIGS. 12A-12B illustrate a method for inputting a vowel ‘ [symbol] (yo)’ according to a moving direction of one touch event according to a second embodiment of the present disclosure;

FIGS. 13A-13B illustrate a method for inputting a vowel ‘ [symbol] (yu)’ according to a moving direction of one touch event according to a second embodiment of the present disclosure;

FIG. 14 illustrates vowels input according to a touch event based on a first cardinal vowel according to a second embodiment of the present disclosure;

FIG. 15 illustrates vowels input according to a touch event based on a second cardinal vowel according to a second embodiment of the present disclosure;

FIG. 16 illustrates vowels input according to a moving direction of two touch events based on a second cardinal vowel according to a second embodiment of the present disclosure;

FIG. 17 illustrates vowels input according to a moving direction of one touch event based on a third cardinal vowel according to a second embodiment of the present disclosure;

FIGS. 18A-18D illustrate vowels input according to a moving direction of a touch event by vowels according to a third embodiment of the present disclosure;

FIG. 19 illustrates a Hanguel input method according to an embodiment of the present disclosure;

FIG. 20 illustrates a method for inputting vowels according to movement of two touch event according to an embodiment of the present disclosure;

FIGS. 21A-21B illustrate a first example of a method for inputting characters according to an embodiment of the present disclosure;

FIGS. 22A-22B illustrate a second example of a method for inputting characters according to an embodiment of the present disclosure;

FIG. 23 illustrates vowels input according to a moving direction of a touch event according to an embodiment of the present disclosure;

FIG. 24 illustrates a third example of a method for inputting characters according to an embodiment of the present disclosure;

FIG. 25 illustrates a fourth example of a method for inputting characters according to an embodiment of the present disclosure; and

FIG. 26 illustrates a character input method according to an embodiment of the present disclosure.

### DETAILED DESCRIPTION OF THE INVENTION

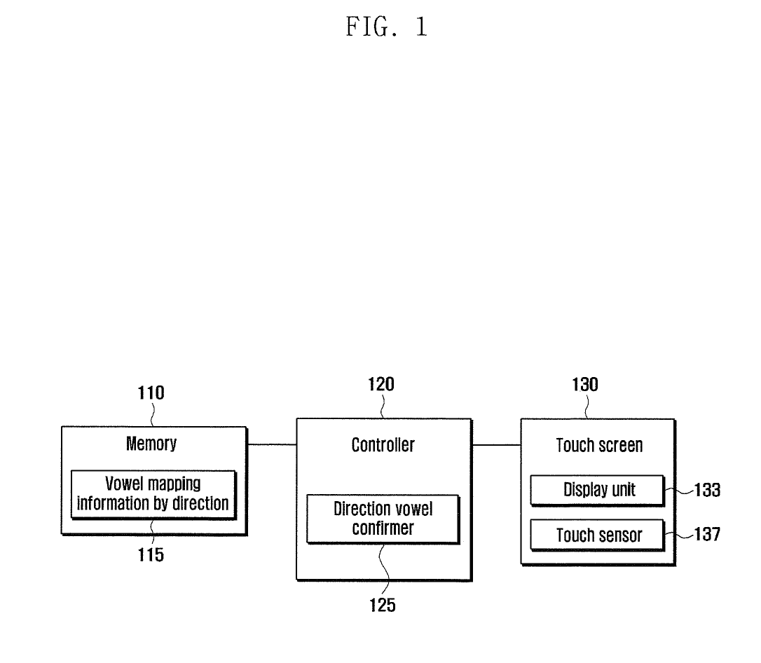

FIGS. 1 through 26, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communications device. As used herein, the term “terminal” means a data processor for processing data created by an external terminal or a user.

As used herein, the term “cardinal vowel” is a character fundamentally displayed on a key pad of a terminal to input vowels, and, may become Cheon (heaven) (•), Ji (land) (-(eu)), In (people) (|(i)) in an input scheme of Cheon Ji In (Cheon/Ji/In).

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

The Korean alphabet consists of 21 vowels and 19 consonants that are arranged in characters and the vowels and consonants are as table 1 and 2.

TABLE 1
Consonants

| | | | | | | | | | | | | | | | | | | | |
|---|---|---|---|---|---|---|---|---|---|---|---|---|---|---|---|---|---|---|---|
| Korea | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
| alphabet | | | | | | | | | | | | | | | | | | | |
| pronounced | b | d | j | g | pp | tt | jj | kk | p | t | ch | k | s | g | ss | m | n | ng | r,l |
| in English | | | | | | | | | | | | | | | | | | | |

TABLE 2
Vowels

| | | | | | | | | | | | | | | | | | | | | |
|---|---|---|---|---|---|---|---|---|---|---|---|---|---|---|---|---|---|---|---|---|
| Korea | \| | [symbol] | [symbol] | [symbol] | [symbol] | [symbol] | [symbol] | — | [symbol] | [symbol] | [symbol] | [symbol] | [symbol] | [symbol] | [symbol] | [symbol] | [symbol] | [symbol] | [symbol] | [symbol] |
| alphabet | | | | | | | | | | | | | | | | | | | | |
| pronounced | i | e | eo | ae | a | o | u | eu | ui | ye | yae | ya | yo | yu | yeo | wi | we | wae | wa | wo |
| in English | | | | | | | | | | | | | | | | | | | | |

The present invention mainly disclose that the terminal and method to input a vowel corresponding to a movement of a touch event when a character is input in Korea language. More specifically, a form of the vowel can be exchanged according to the movement of the touch event.

FIG. 1 illustrates a configuration of a terminal according to an exemplary embodiment of the present disclosure.

Referring to FIG. 1, the terminal includes a memory 110, a controller 120, and a touch screen 130.

The memory 110 stores data created during a function operation of the terminal as well as programs necessary for the function operation of the terminal. In this case, the memory 110 stores vowel mapping information 115 for each direction such that vowels may be input according to a moving direction of a touch event sensed through the touch screen. More particularly, the vowel mapping information 115 by directions is information with respect to vowels that may be changed according to a moving direction of each touch event based on the cardinal vowels. For example, the vowel mapping information 115 by directions may indicate that a vowel ‘ [symbol] (a)’, a vowel ‘ [symbol] (o)’, a vowel ‘ [symbol] (eo)’, and a vowel ‘ [symbol] (u)’ are mapped to a right direction, an upward direction, a left direction, and a downward direction of a moving direction of a touch event based a cardinal vowel ‘Cheon’.

The controller 120 may control an overall operation of the terminal and signal flow between internal elements of the terminal, and have a data processing function. In particular, the controller 120 may display vowels on the display unit 133 according to a moving direction of a touch event through the touch screen 130. To do this, the controller 120 includes a direction vowel confirmer 125.

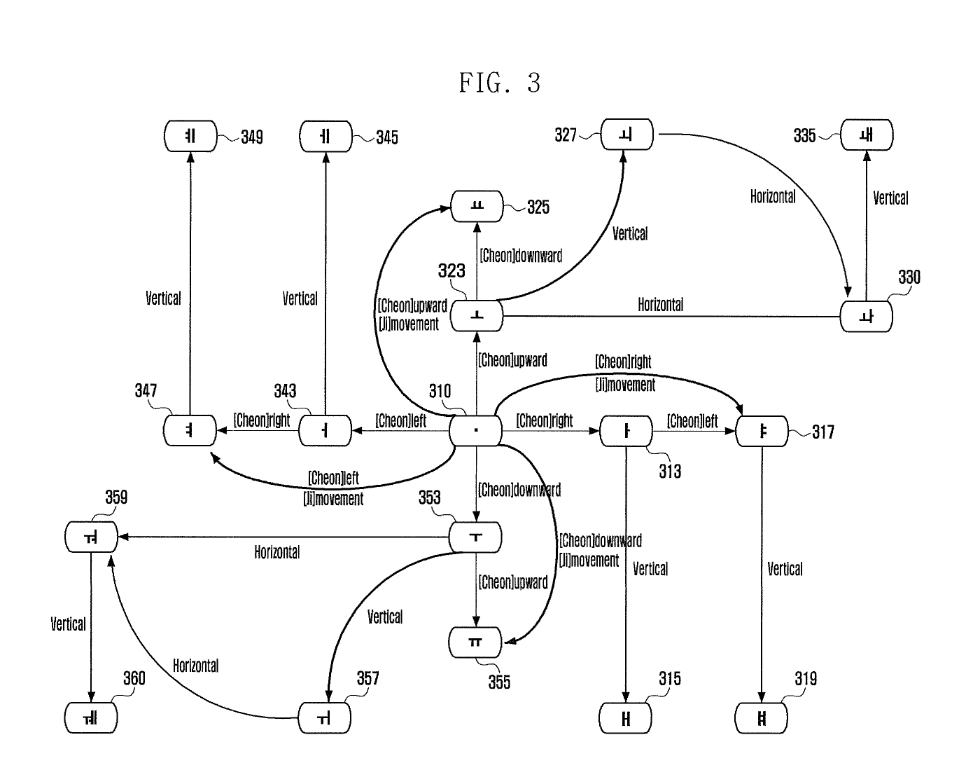

If a vowel input order comes in a character input mode such message transmission, memo, character creation, the direction vowel confirmer 125 may confirm vowels according to a moving direction of a sensed touch event to display them on the display unit 133. In detail, if a touch event is sensed through the touch screen 130, the direction vowel confirmer 125 displays characters mapped to a region in which a touch event is sensed on the display unit 133. The direction vowel confirmer 125 determines whether a touch event is released. If the touch event is not released, the direction vowel confirmer 125 determines a moving direction of a touch event. Then, the direction vowel confirmer 125 displays vowels according to a moving direction of the touch event. Further, if a touch event is sensed in at least two regions through the touch screen 130, the direction vowel confirmer 125 may display vowels according to movement of two sensed touch events. In this case, the direction vowel confirmer 125 uses vowel mapping information 115 by directions stored in the memory 110. A method for displaying vowels according to a moving direction of a touch event will be described with reference to FIGS. 3 to 18 below.

If vowels are displayed on the display unit 133 through the direction vowel confirmer 125, the controller 120 determines whether touch release is sensed through the touch screen 130. If the touch release is sensed, the controller 120 recognizes the displayed vowels as a character, waits for input of next character or determines whether a character input mode is terminated. If termination of the character input mode is selected, the controller 120 performs a function according to the termination of the character input. In this case, the function may become message transmission, document storage, and memo storage.

The touch screen 130 includes a display unit 133 and a touch sensor 137 disposed at a side of the display unit 133. The display unit 133 displays information input by a user or information provided to the user as well as various menus of the terminal. In this case, the display unit 133 maybe configured by a Liquid Crystal Display (LCD). When a character input mode is selected, the display unit 133 displays a virtual key pad for inputting characters and an input window for displaying input characters under the control of the controller 120. Further, the display unit 133 may display vowels according to a moving direction of a touch event on an input window under the control of the controller 120.

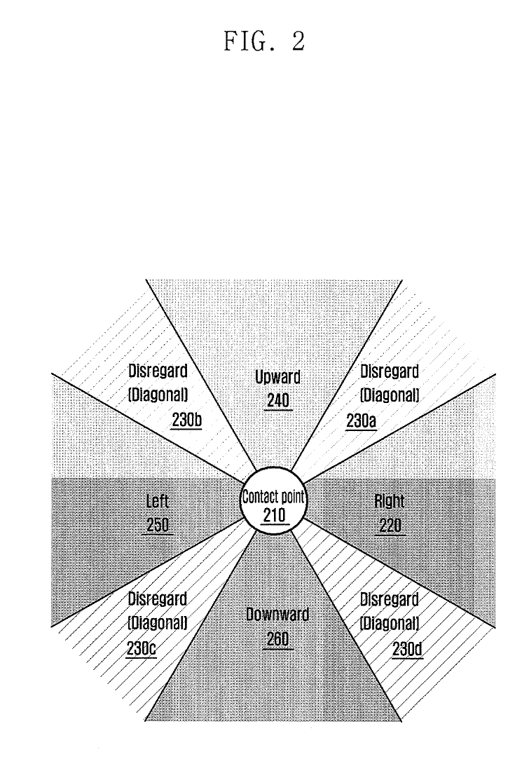

The touch sensor 137 is installed at a side of the display unit 133, and may sense a touch event created on a surface of the display unit 133. Moreover, the touch sensor 137 may detect coordinates, namely, a location value of a region in which the touch event occurs. The touch sensor 137 may operate in a resistive overlay type, a capacitive type, an ultrasonic reflection type, optical sensor and electro-magnetic induction type. In this case, the touch sensor 137 senses and transfers a moving direction of the touch event to the controller 120. The moving direction of the touch event will be explained with reference to FIG. 2 below.

In a character input mode, the terminal having a construction as illustrated above may display vowels on the display unit 133 according to a moving direction of the touch event sensed through the touch screen 130. In this case, the terminal may display vowels input according to a moving direction of at least two sensed touch events. Further, the terminal may display vowels input according to a moving direction, namely, upward direction, downward direction, right direction, left direction, and rotation direction.

FIG. 2 illustrates a moving direction of a touch event according to an embodiment of the present disclosure.

Referring to FIG. 2, the controller 120 may determine a moving direction of the touch event based on a contact point 210 being a sensed region of the touch event. That is, the controller 120 may determine a right direction 220, diagonal directions 230a, 230b, 230c, and 230d, an upward direction 240, and a left direction 250, and a downward direction 260 based on the contact point 210. For example, it is assumed that coordinates of the contact point 210 are (0,0). If moved coordinates of the touch event are (+n, 0), the controller 120 determines a moving direction of the touch event as the right direction 220. Further, if the moved coordinates of the touch event are (n, n), the controller 120 determines the moving direction of the touch event as the diagonal directions 230a, 230b, 230c, and 230d. If the moving coordinates of the touch event are (0, +n), the controller 120 determines the moving direction of the touch event as the upward direction 240. Next, if moved coordinates of the touch event are (−n, 0), the controller 120 determines the moving direction of the touch event as the left direction 250. Finally, the moved coordinates of the touch event are (0, −n), the controller 120 determines the moving direction of the touch event as the downward direction 260.

If it is sensed that coordinates according to movement of the touch event change from the upward direction 240 to the downward direction 260 or from the downward direction 260 to the upward direction 240, the controller 120 determines it as the vertical direction. If it is sensed that coordinates according to movement of the touch event change from the right direction 220 to the left direction 250 or from the left direction 250 to the right direction 220, the controller 120 determines it as the horizontal direction. In case when at least two touch event are sensed, if coordinates change from the horizontal direction to the vertical direction in a sensed region of a second touch event, the controller 120 determines it as movement.

In this case, n is an optional indicating coordinates. Coordinates suggested for determining the moving direction is to more easily a moving direction by way of example. However, the present invention is not limited thereto. That is, coordinates set to sense each moving direction may be changed according to a manufacturing company of the terminal or selection of the user.

Next, a character input method according to a moving direction of the touch event will be illustrated with reference to FIGS. 3 to 18. It is assumed that a key pad for character input is a Cheon Ji In type. Vowels displayed according to a moving direction of each touch event are confirmed through vowel mapping information 115 by directions stored in the memory 110.

FIG. 3 illustrates vowels input according to a touch event based on a first cardinal vowel according to a first embodiment of the present disclosure. First, the controller 120 displays characters mapped to a sensed region of a first touch event. If release of the touch event is not sensed, the controller 120 determines that a Cheon is mapped to the corresponding region. If release of a touch is not sensed although some characters are mapped to a sensed region of a first touch event, the terminal is changed to a Cheon input mode in which vowels are input according to a moving direction of the Cheon. In this case, the controller 120 may display vowels according to a moving direction of a sensed touch event using previously stored vowel mapping information by directions.

Referring to FIG. 3, if a first touch event sensed in a mapped region of a ‘Cheon’ 310 is moved to a right direction, the controller 120 displays a ‘ [symbol] (a)’ 313 on the display unit 133. If a first touch event is vertically moved in a displayed state of the ‘ [symbol] (a)’ 313, the controller 120 displays a ‘ [symbol] (ae)’ 315 on the display unit 133. If the first touch event is again moved to a left direction in a displayed state of the ‘ [symbol] (a)’ 313, the controller 120 displays a ‘ [symbol] (a)’ 317 on the display unit 133. If the first touch event is vertically moved in a displayed state of the ‘ [symbol] (ya)’ 317, the controller 120 displays a ‘ [symbol] (yae)’ 319 on the display unit 133.

There is a method using two touch events as an example of a method for changing a ‘Cheon’ 310 to a ‘ [symbol] (ya)’ 317 having two horizontal right extending strokes. That is, if a first touch event sensed in a mapped region of a ‘Cheon’ 310 is moved to a right direction and a second touch event sensed in remaining regions except for the sensed region of the first touch event, the controller 120 displays a ‘ [symbol] (ya)’ 317 on the display unit 133. In this case, the controller 120 recognizes the second sensed touch event as the Ji. In other words, the controller 120 changes the terminal to a Ji input mode for adding a stroke to a vowel according to a moving direction of the Ji.

If a first touch event is moved upwards in a mapped region of the ‘Cheon’ 310, the controller 120 displays a ‘ [symbol] ’ (o) 323 on the display unit 133. If the first touch event is moved downwards in a displayed state of the ‘ [symbol] (o)’ 323, the controller 120 displays a ‘ [symbol] (yo)’ 325 on the display unit 133. In this case, there is a method using two touch events as an example of a method for changing a ‘Cheon’ 310 to a ‘ [symbol] (yo)’ 325 having two upward extending strokes. That is, if the first touch event is moved upwards and the second touch event is horizontally or vertically moves, the controller 120 displays a ‘ [symbol] (yo)’ 325 on the display unit 133. In this case, the controller 120 recognizes the second sensed touch event as a Ji. In other words, the controller 120 changes the terminal to a Ji input mode for adding a stroke to a vowel according to a moving direction of the Ji.

If a second touch event sensed in one of remaining regions except for sensed regions of a first touch event in a displayed state of a ‘ [symbol] (o)’ 323 is moved, the controller 120 displays a ‘ [symbol] (oe)’ 327 on the display unit 133. If the second touch event is horizontally moved in a displayed state of a ‘ [symbol] (oe)’ 327, the controller 120 display a ‘ [symbol] (wa)’ 330 on the display unit 133. If the second touch event is vertically moved in a displayed state of the ‘ [symbol] (wa)’ 330, the controller 120 displays a ‘ [symbol] (wae)’ 335 on the display unit 133. If the second touch event is horizontally moved in a displayed state of a ‘ [symbol] (o)’ 323 in an input method of a ‘ [symbol] (wa)’ 330, the controller 120 may display the ‘ [symbol] (wa)’ 330 on the display unit 133.

If the first touch event sensed in a mapped region of a ‘Cheon’ 310 is moved to a left direction, the controller 120 displays a ‘ [symbol] (eo)’ 343 on the display unit 133. If the first touch event is vertically moved in a displayed state of a ‘ [symbol] (eo)’ 343, the controller 120 displays a ‘ [symbol] (e)’ 345 on the display unit 133.

If the first touch event is again moved to a right direction in a displayed state of the ‘ [symbol] (eo)’ 343, the controller 120 displays a ‘ [symbol] (yeo)’ 347 on the display unit 133. If the first touch event is vertically moved in a displayed state of a ‘ [symbol] (yeo)’ 347, the controller 120 displays a ‘ [symbol] (ye)’ 349 on the display unit 133.

There is a method using two touch events as an example of a method for changing a ‘Cheon’ 310 to a ‘ [symbol] (yeo)’ 347 having two horizontal left extending strokes. That is, if a first touch event sensed at a mapped region of a ‘Cheon’ 310, and a second touch event sensed in one of remaining regions except for a sensed region of a first touch event is horizontally or vertically moved, the controller 120 displays a ‘ [symbol] (yeo)’ 347 on the display unit 133.

If a first touch event is moved downwards in a mapped region of a ‘Cheon’ 310, the controller 120 displays a ‘ [symbol] (u)’ 353 on the display unit 133. Moreover, if the first touch event is moved upwards in a displayed state of a ‘ [symbol] (u)’ 353, the controller 120 displays ‘ [symbol] (yu)’ 355 on the display unit 133. In this case, there is a method using two touch events as an example of a method for changing a ‘Cheon’ 310 to a ‘ [symbol] (yu)’ 355 having two horizontal left extending strokes.

That is, if a first touch event sensed at a mapped region of a ‘Cheon’ 310 is moved downwards, and a second touch event sensed at a mapped region of a ‘Ji’ is horizontally or vertically moved, the controller 120 displays a ‘ [symbol] (yu)’ 355 on the display unit 133.

If the second touch event is vertically moved in a displayed state of a ‘ [symbol] (u)’ 353, the controller 120 displays a ‘ [symbol] (wi)’ 357 on the display unit 133. If a first or second touch event is horizontally moved in a displayed state of a ‘ [symbol] (wi)’ 357, the controller 120 displays a ‘ [symbol] (wo)’ 359 on the display unit 133. If the first or second touch event is vertically moved in a displayed state of a ‘ [symbol] (wo)’ 359, the controller 120 displays a ‘ [symbol] (we)’ 360 on the display unit 133. In this case, if the first touch event is horizontally moved in a displayed state of a ‘ [symbol] (u)’ 353 in an input scheme of a ‘ [symbol] (wo)’ 359, the controller 120 may display a ‘ [symbol] (wo)’ 330 on the display unit 133.

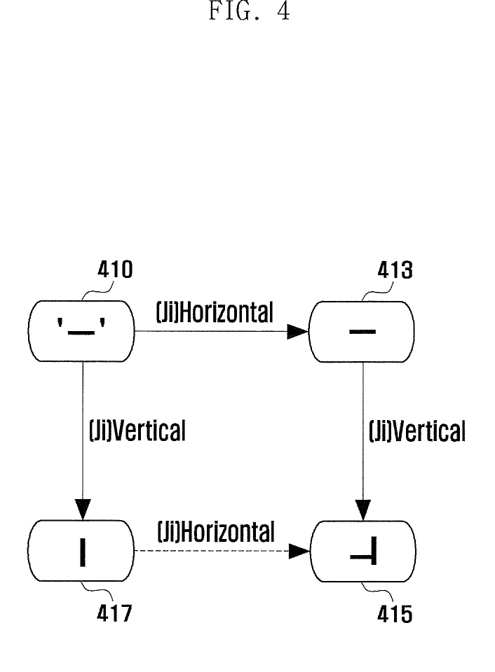

FIG. 4 illustrates vowels input according to a moving direction of one touch event based on a second cardinal vowel according to a first embodiment of the present disclosure. In this case, if the first touch event occurs, a second touch event occurs in another region in a maintained state of a touch, and a second touch is moved, a ‘Ji(-(eu))’ is mapped and input.

Referring to FIG. 4, the controller 120 checks a ‘Ji’ 410 being a cardinal vowel mapped to a sensed region of a touch event. If the touch event is horizontally moved, the controller 120 displays a ‘-(eu)’ 413 on the display unit 133. If the touch event is vertically moved in a displayed state of a ‘-(eu)’ 413, the controller 120 displays a ‘ [symbol] (ui)’ 415 on the display unit 133. Moreover, the touch event is vertically moved, the controller 120 displays a ‘|(i)’ 417 on the display unit 133. If the touch event is horizontally moved in a displayed state of a ‘|(i)’ 417, the controller 120 may display a [symbol] (ui)’ 415.

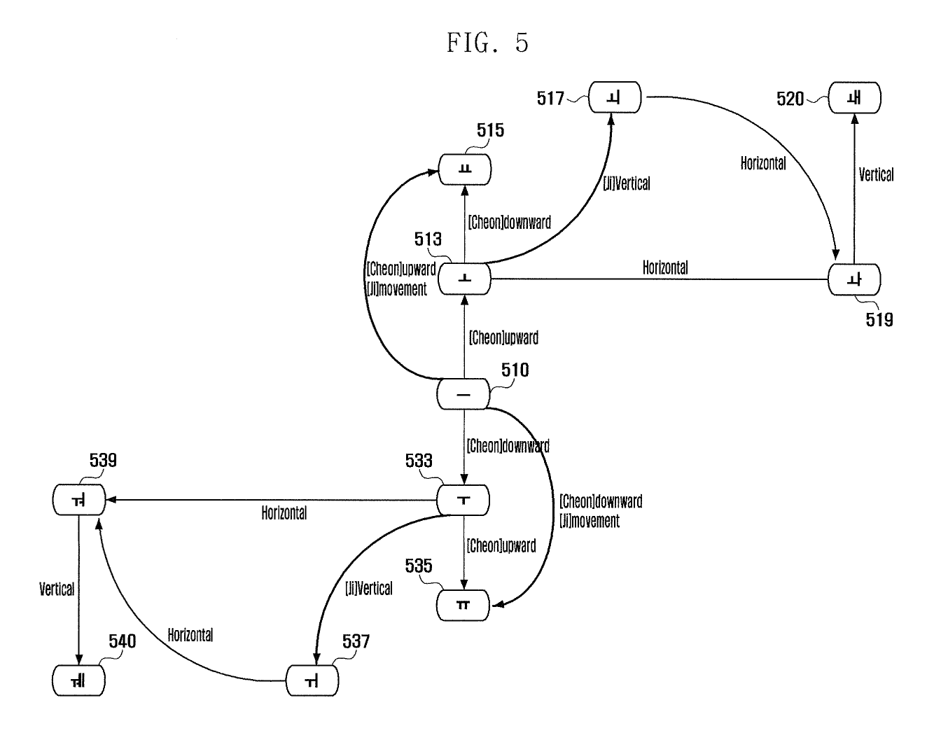

FIG. 5 illustrates vowels input according to a moving direction of two touch events based on a second cardinal vowel according to a first embodiment of the present disclosure.

Referring to FIG. 5, if a ‘-(eu)’ 413 is input in FIG. 4 or a first touch event is moved upwards without releasing a first touch event in a state that a key pad selects a ‘-(eu)’ 510 as a first touch event, the controller 120 displays a ‘ [symbol] (o)’ 513 on the display unit 133. If a first touch event is moved downwards in a displayed state of a ‘ [symbol] (o)’ 513, the controller 120 displays a ‘ [symbol] (yo)’ 515 on the display unit 133. In this case, there is a method using two touch events as an example of a method for changing a ‘Ji’ 510 to a ‘ [symbol] (yo)’ 515 having two upward extending strokes. That is, if a first touch event sensed in a mapped region of a ‘Ji’ 510 is vertically moved, and a second touch event at any region of remaining regions except for sensed regions of a first touch event is horizontally or vertically moved, a controller 120 displays a ‘ [symbol] (yo)’ 515 on the display unit 133.

If the second touch event is vertically moved in a displayed state of a ‘ [symbol] (o)’ 513, the controller 120 displays a ‘ [symbol] (oe)’ 517 on the display unit 133. Further, if a first or second touch event is horizontally moved in a displayed state of a ‘ [symbol] (oe)’ 517, the controller 120 displays a ‘ [symbol] (wa)’ 519 on the display unit 133. If the first or second touch event is vertically moved in a displayed state of a ‘ [symbol] (wa)’ 519, the controller 120 displays a ‘ [symbol] (wae)’ 520 on the display unit 133. In this case, if the first touch event is horizontally moved in a displayed state of a ‘ [symbol] (o)’ 513 in an input scheme of a ‘ [symbol] (wa)’ 519, the controller 120 may display a ‘ [symbol] (wa)’ 519 on the display unit 133. If the first touch event is moved downwards in an input state of a ‘-(eu)’ 510, the controller 120 displays a ‘ [symbol] (u)’ 533 on the display unit 133. Further, if the first touch event is moved upwards in a displayed state of a ‘ [symbol] (u)’ 533, the controller 120 displays a ‘ [symbol] (yu)’ 535 on the display unit 133. In this case, there is a method using two touch events as an example of a method for changing a ‘Ji’ 510 to a ‘ [symbol] (yu)’ 535 having two upward extending strokes. That is, if a first touch event is moved downwards in an input state of a ‘-(eu)’ 510, and the second touch event is horizontally or vertically moved, the controller 120 displays a ‘ [symbol] (yu)’ 535 on the display unit 133.

If the second touch event is vertically moved in a displayed state of a ‘ [symbol] (u)’ 533, the controller 120 displays a ‘ [symbol] (wi)’ 537 on the display unit 133. If the first or second touch event is horizontally moved in a displayed state of a ‘ [symbol] (wi)’ 537, the controller 120 displays a ‘ [symbol] (wo)’ 539 on the display unit 133. When the first or second touch event is vertically moved in a displayed state of the ‘ [symbol] (wo)’ 539, the controller 120 displays a ‘ [symbol] (we)’ 540 on the display unit 133. In this case, if a first or second touch event is horizontally moved in a displayed state of a ‘ [symbol] (u)’ 533 in an input scheme of a ‘ [symbol] (wo)’ 539, the controller 120 may display a ‘ [symbol] (wo)’ 539 on the display unit 133.

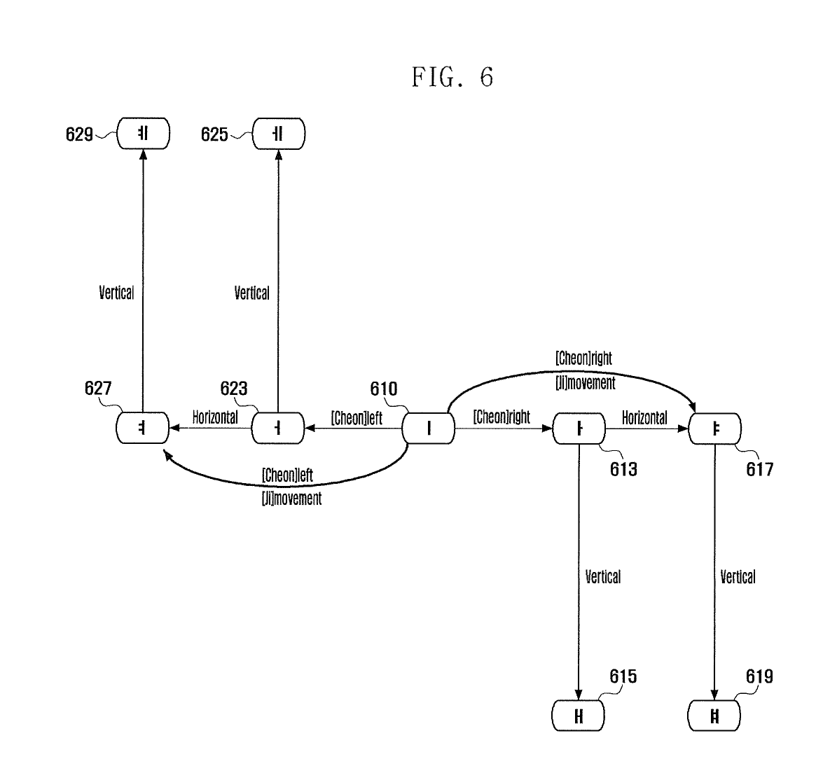

FIG. 6 illustrates vowels input according to a moving direction of two touch events based on a second cardinal vowel according to a first embodiment of the present disclosure.

Referring to FIG. 6, if a ‘|(i)’ 417 is input in FIG. 4 or the first touch event is moved to a right direction in a state that a key pad selects the ‘|(i)’ as a first touch event, the controller 120 displays a ‘ [symbol] (a)’ 613 on the display unit 133. If the first or second event is vertically moved in a displayed state of a ‘ [symbol] (a)’ 613, the controller 120 displays a ‘ [symbol] (ae)’ 615 on the display unit 133. If a first or second touch event is horizontally moved in a displayed state of a ‘ [symbol] (a)’ 613, the controller 120 displays the ‘ [symbol] (ya)’ 617 on the display unit 133. If the first or second touch event is vertically moved, the controller 120 displays a ‘ [symbol] (yae)’ 619 on the display unit 133.

There is a method using two touch events as an example of a method for changing a ‘|(i)’ 610 to a ‘ [symbol] (ya)’ 617 having two horizontal right extending strokes. That is, if a first touch event sensed in a mapped region of a ‘|(i)’ 610, or a second touch event sensed at one of remaining regions except for sensed regions of the first touch event, the controller 120 displays a ‘ [symbol] (ya)’ 617 on the display unit 133.

If the first touch event sensed at a mapped region of a ‘|(i)’ 610 is moved to a left direction, the controller 120 displays a ‘ [symbol] (eo)’ 623 on the display unit 133. If a first or second touch event is vertically moved in a displayed state of a ‘ [symbol] (eo)’ 623, the controller 120 displays a ‘ [symbol] (e)’ 625 on the display unit 133. If the first or second touch event is horizontally moved in a displayed state of the ‘ [symbol] (eo)’ 623, the controller 120 displays a ‘ [symbol] (yeo)’ 627 on the display unit 133. If the first or second touch event is vertically moved in a displayed state of a ‘ [symbol] (yeo)’ 627, the controller 120 displays a ‘ [symbol] (ye)’ 629 on the display unit 133.

There is a method using two touch events as an example of a method for changing a ‘|(i)’ 610 to a ‘ [symbol] (yeo)’ 627 having two horizontal left extending strokes. That is, a first touch event sensed at a mapped region of a ‘|(i)’ 610 and a second touch event sensed at any one of remaining regions except for a sensed region of the first touch event is horizontally or vertically moved, the controller 120 displays a ‘ [symbol] (yeo)’ 627 on the display unit 133.

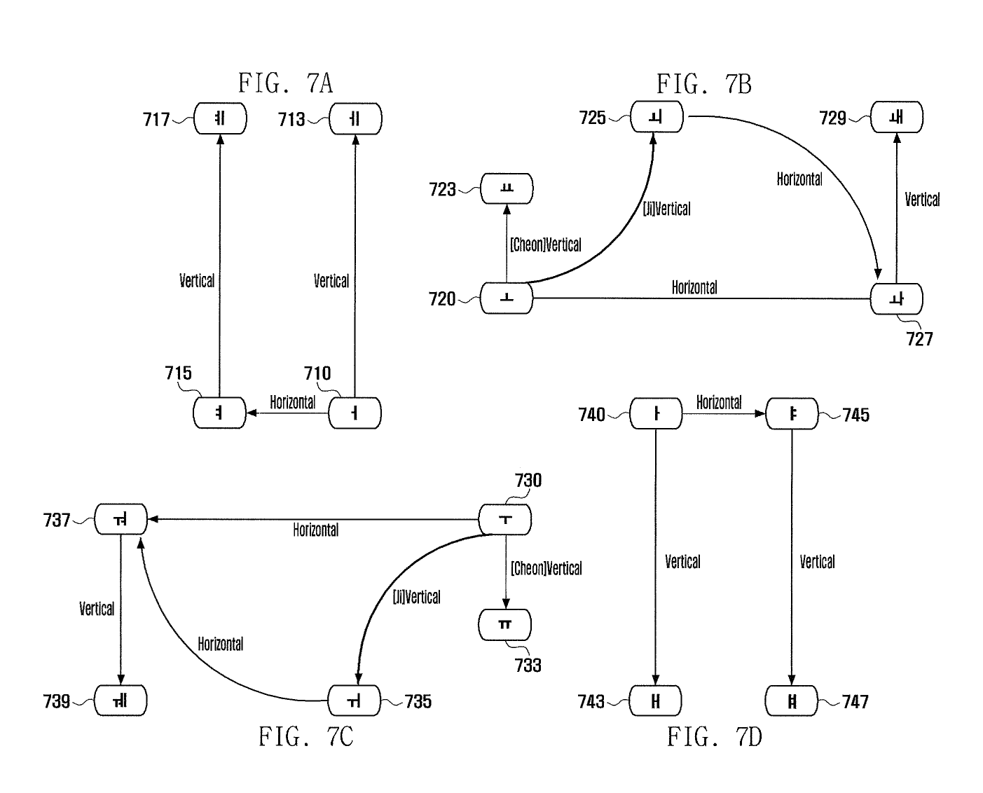

FIGS. 7A-7D illustrate a procedure that is changed according to a moving direction of a touch event by vowels according to a first embodiment of the present disclosure. Referring to FIG. 7A, it is assumed that a vowel ‘ [symbol] (eo)’ 710 is input as a first touch to be displayed on the display unit 133. If the first or second sensed touch event is vertically moved, the controller 120 displays a ‘ [symbol] (e)’ 713 on the display unit 133. If the first or second touch event is horizontally moved in a displayed state of a ‘ [symbol] (eo)’ 710, the controller 120 displays a ‘ [symbol] (yeo)’ 715 on the display unit 133. If the first or second touch event is vertically moved in a displayed state of the ‘ [symbol] (yeo)’ 715, the controller 120 displays a ‘ [symbol] (ye)’ 717 on the display unit 133.

Referring to FIG. 7B, it is assumed that a vowel ‘ [symbol] (o)’ 720 is input as a first touch to be displayed on the display unit 133. If a first sensed touch event is vertically moved, the controller 120 displays a ‘ [symbol] (yo)’ 723 on the display unit 133. If the second touch event is vertically moved in a displayed state of a ‘ [symbol] (o)’ 720, the controller 120 displays a ‘ [symbol] (oe)’ 725 on the display unit 133. If the first or second touch event is horizontally moved in a displayed state of a ‘ [symbol] (oe)’ 725, the controller 120 displays a ‘ [symbol] (wa)’ 727 on the display unit 133. If the first or second touch event is vertically moved in a displayed state of a ‘ [symbol] (wa)’ 727, the controller 120 displays a ‘ [symbol] (wae)’ 729 on the display unit 133. In this case, if a first or second sensed touch event is horizontally moved in an allotted region of a

cardinal vowel ‘Ji’ in a displayed state of a ‘ [symbol] (o)’ 720, the controller 120 may display a ‘ [symbol] (wa)’ 727 on the display unit 133.

Referring to FIG. 7C, it is assumed that a vowel ‘ [symbol] (o)’ 720 is input as a first touch to be displayed on the display unit 133. If a first touch event sensed is vertically moved in a displayed state of a ‘ [symbol] (u)’ 730, the controller 120 displays a ‘ [symbol] ’ 733 on the display unit 133.

If a second touch event sensed in a displayed state of a ‘ [symbol] (u)’ 533 is vertically moved, the controller 120 displays a ‘ [symbol] (wi)’ 735 on the display unit 133. If the first or second touch event is horizontally moved in a displayed state of a ‘ [symbol] (wi)’ 735, the controller 120 displays a ‘ [symbol] (wo)’ 737 on the display unit 133. If the first or second touch event is vertically moved in a displayed state of a ‘ [symbol] (wo)’ 737, the controller 120 displays a ‘ [symbol] (we)’ 739 on the display unit 133. In this case, the first or second touch event is horizontally moved in a displayed state of a ‘ [symbol] (u)’ 730 in an input scheme of a ‘ [symbol] (wo)’ 737, the controller 120 may display a ‘ [symbol] (wo)’ 737 on the display unit 133.

Referring to FIG. 7D, it is assumed that a vowel ‘ [symbol] (a)’ 740 is input as a first touch to be displayed on the display unit 133. If the first or second sensed touch event is vertically moved, the controller 120 displays a ‘ [symbol] (ae)’ 743 on the display unit 133.

If the first or second touch event is again moved horizontally in a displayed state of a ‘ [symbol] (a)’ 740, the controller 120 displays a ‘ [symbol] (ya)’ 745 on the display unit 133. If the first or second touch event is vertically moved in a displayed state of a ‘ [symbol] (ya)’ 745, the controller 120 displays a ‘ [symbol] (yae)’ 747 on the display unit 133.

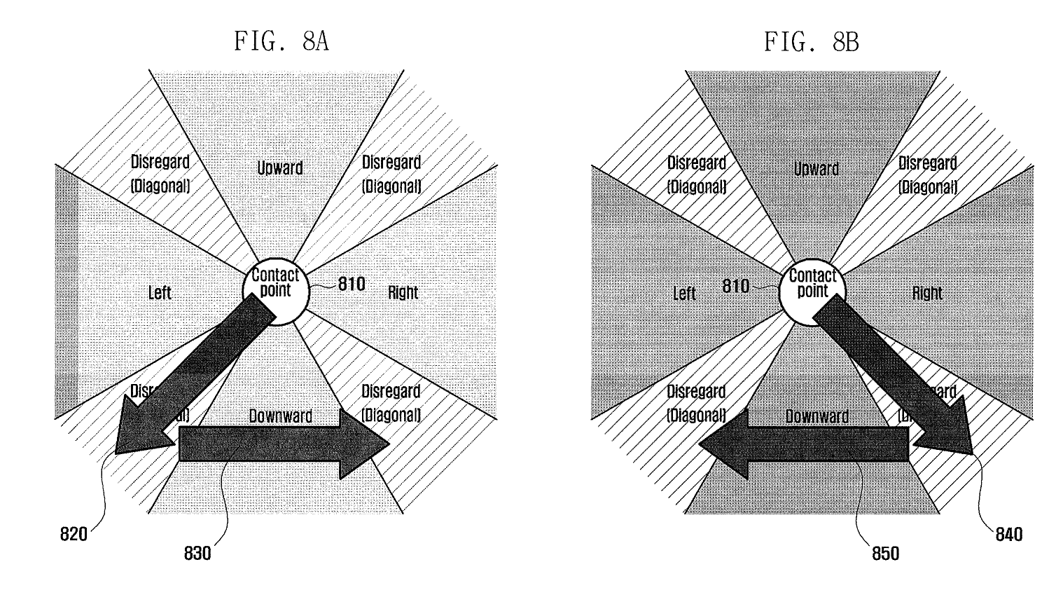

FIGS. 8A-8B illustrate a method for inputting a vowel ‘-(eu)’ according to a moving direction of one touch event according to a second embodiment of the present disclosure.

Referring to FIG. 8A, if a touch event is moved to a horizontal direction 830 after change of a moving direction while moving in a lower left diagonal 820 direction based on a contact point 810, the controller 120 displays a vowel ‘-(eu)’ on the display unit 133. Referring to FIG. 8B, if a touch event is moved to a horizontal direction 850 after change of a moving direction while moving in a lower right diagonal 840 direction based on a contact point 810, the controller 120 displays a vowel ‘-(eu)’ on the display unit 133.

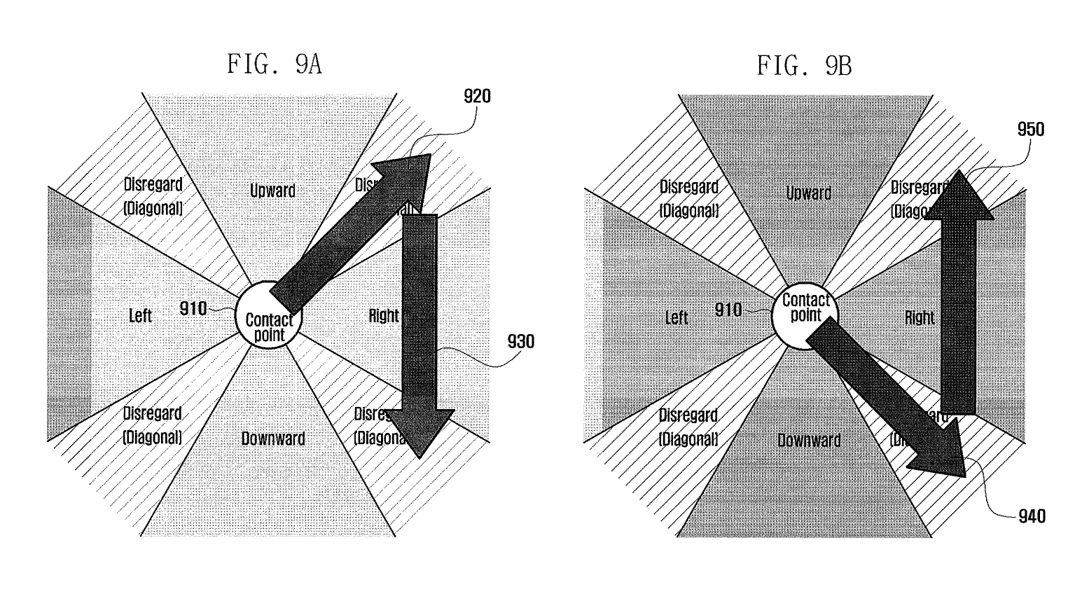

FIGS. 9A-9B illustrate a method for inputting a vowel ‘|(i)’ according to a moving direction of one touch event according to a second embodiment of the present disclosure.

Referring to FIG. 9A, if a touch event is moved to a vertical direction 930 after change of a moving direction while moving in a upper right diagonal 920 direction based on a contact point 810, the controller 120 displays a vowel ‘|(i)’ on the display unit 133. Referring to FIG. 9B, if a touch event is moved to a vertical direction 950 after change of a moving direction while moving in a lower right diagonal 940 direction based on a contact point 810, the controller 120 displays a vowel ‘|(i)’ on the display unit 133.

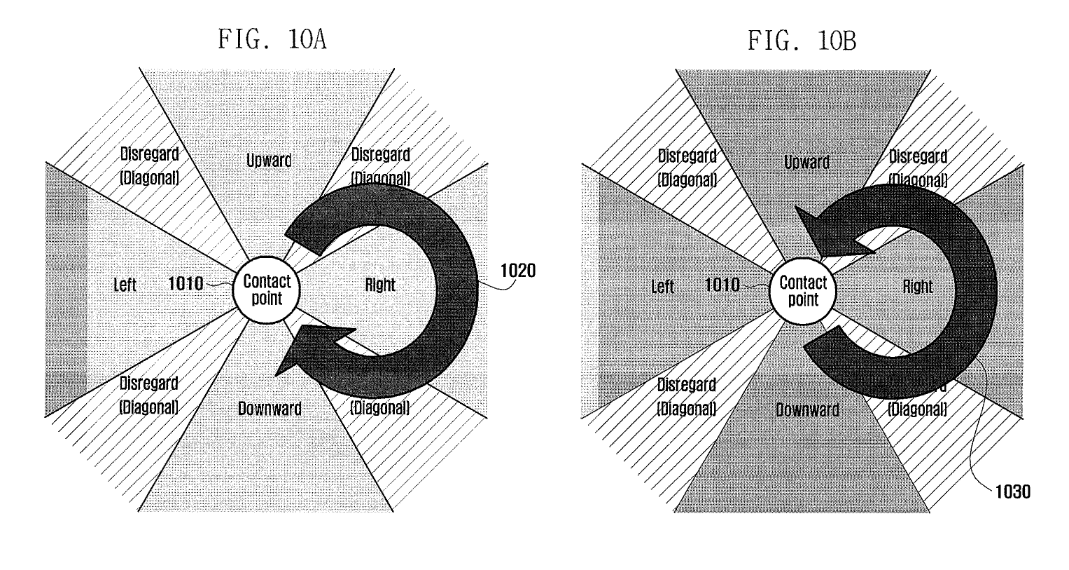

FIGS. 10A-10B illustrate a method for inputting a vowel ‘ [symbol] (ya)’ according to a moving direction of one touch event according to a second embodiment of the present disclosure.

Referring to FIG. 10A, if a touch event rotates from an upper right diagonal direction to a lower right diagonal direction 1020 based on a contact point 1010, the controller 120 displays a ‘ [symbol] (ya)’ on the display unit 133. Referring to FIG. 10b, if a touch event rotates from a lower right diagonal direction to an upper right diagonal direction 1030 based on a contact point 1010, the controller 120 displays a ‘ [symbol] (ya)’ on the display unit 133.

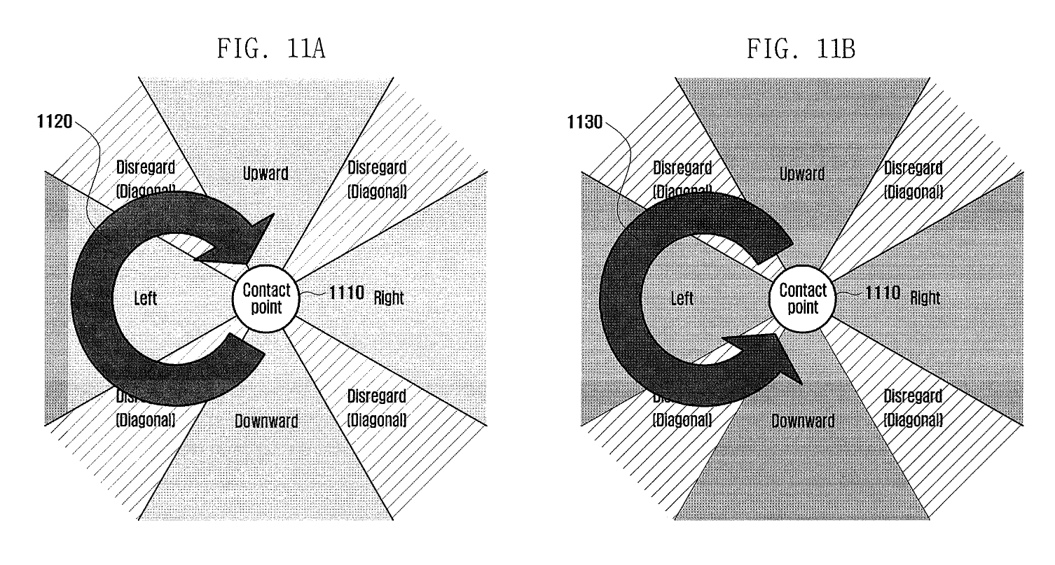

FIGS. 11A-11B illustrate a method for inputting a vowel ‘ [symbol] (yeo)’ according to a moving direction of one touch event according to a second embodiment of the present disclosure.

Referring to FIG. 11A, if a touch event rotates from a lower left diagonal direction to a lower left diagonal direction 1120 based on a contact point 1110, the controller 120 displays a ‘ [symbol] (yeo)’ on the display unit 133. Referring to FIG. 11B, if a touch event rotates from an upper left diagonal direction to a lower left diagonal direction 1130 based on a contact point 1110, the controller 120 displays a ‘ [symbol] (yeo)’ on the display unit 133.

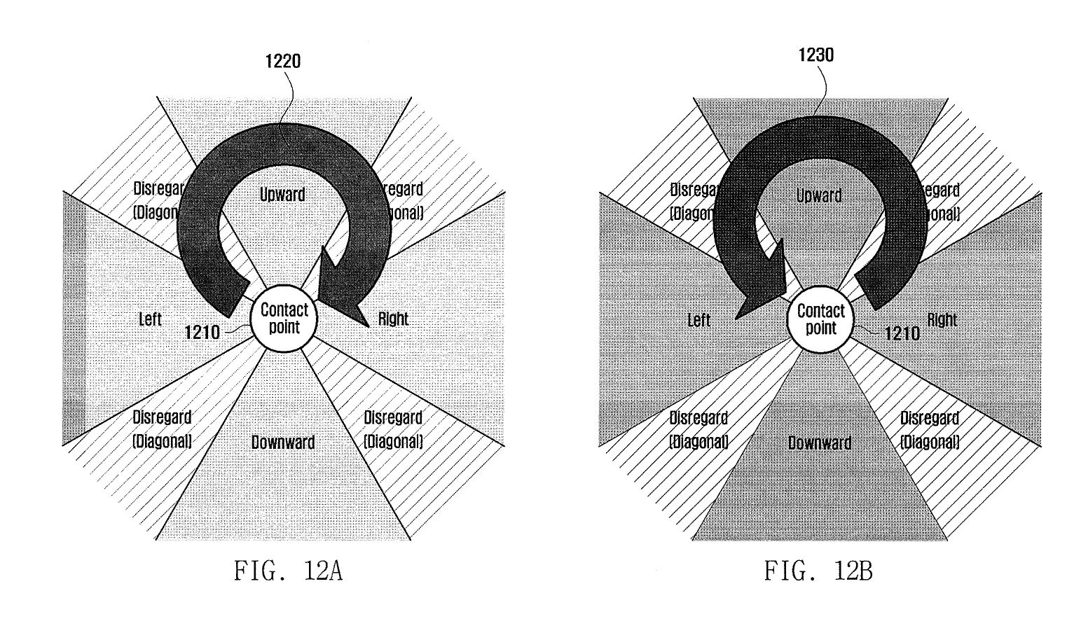

FIGS. 12A-12B illustrate a method for inputting a vowel ‘ [symbol] (yo)’ according to a moving direction of one touch event according to a second embodiment of the present disclosure.

Referring to FIG. 12A, if a touch event rotates from an upper left diagonal direction to an upper right diagonal direction 1220 based on a contact point 1210, the controller 120 displays a ‘ [symbol] (yo)’ on the display unit 133. Referring to FIG. 12B, if a touch event rotates from an upper right diagonal direction to an upper left diagonal direction 1230 based on a contact point 1210, the controller 120 displays a ‘ [symbol] (yo)’ on the display unit 133.

FIGS. 11A-11B illustrate a method for inputting a vowel ‘ [symbol] (u)’ according to a moving direction of one touch event according to a second embodiment of the present disclosure.

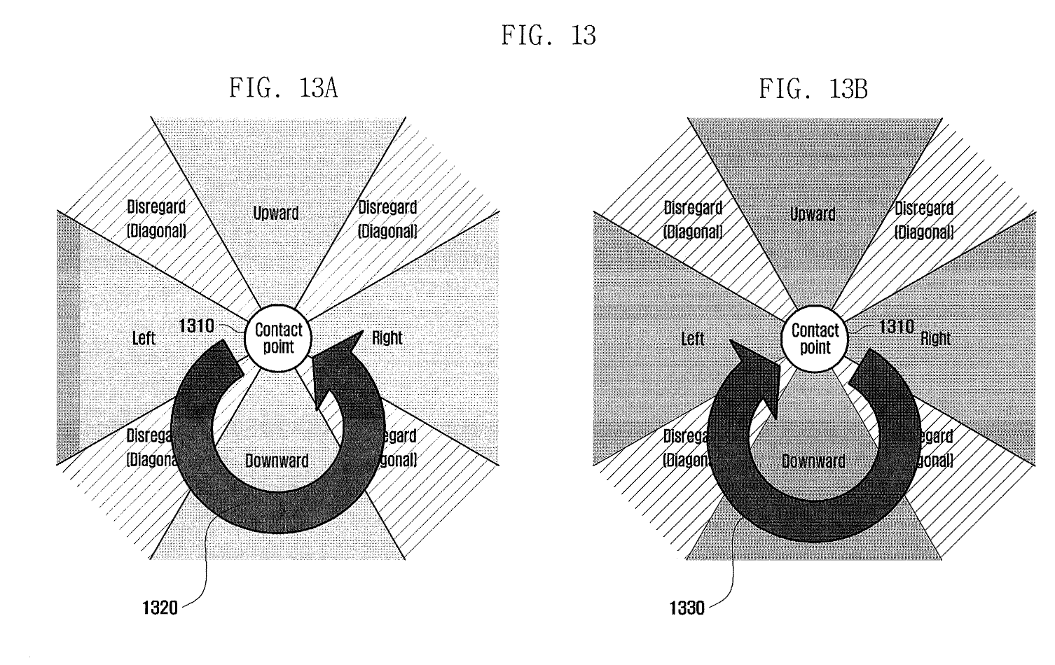

Referring to FIG. 13A, if a touch event rotates from a lower left diagonal direction to a lower right diagonal direction 1320 based on a contact point 1310, the controller 120 displays a ‘ [symbol] (u)’ on the display unit 133. Referring to FIG. 13B, if a touch event rotates from a lower right diagonal direction to a lower left diagonal direction 1330 based on a contact point 1310, the controller 120 displays a ‘ [symbol] (u)’ on the display unit 133.

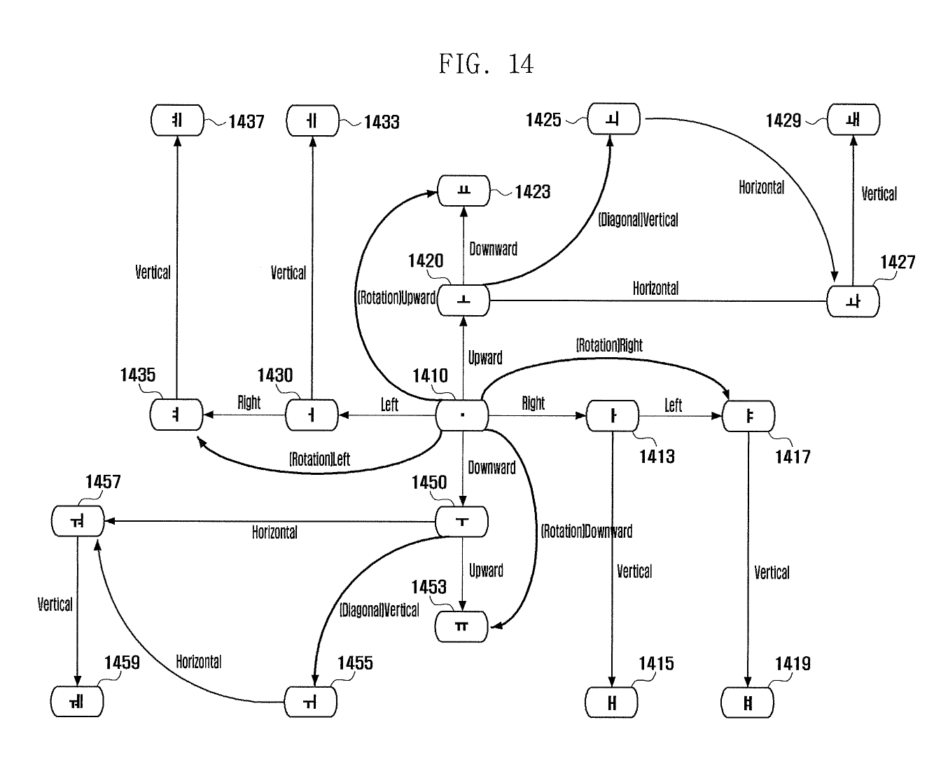

Prior to a description of FIGS. 14 to 17, terms regarding a rotation direction are defined as follows. Upper rotation direction movement means rotation from an upper right diagonal direction to an upper left diagonal direction or from an upper left diagonal direction to an upper right diagonal direction. Lower rotation direction movement means rotation from a lower right diagonal direction to a lower left diagonal direction or from the lower left diagonal direction to the lower right diagonal direction. Right rotation direction movement means rotation from an upper right diagonal direction to a lower right diagonal direction or from the lower right diagonal direction to the upper right diagonal direction. Left rotation direction movement means rotation from a lower left diagonal direction to an upper left diagonal direction or from the upper left diagonal direction to the lower left diagonal direction.

FIG. 14 illustrate vowels input according to a touch event based on a first cardinal vowel according to a second embodiment of the present disclosure. It is assumed that a first cardinal vowel is a ‘Cheon’.

Referring to FIG. 14, it is assumed that an occurring point of a touch in a key region on which a consonant is displayed is displayed as a ‘Cheon’ 1410. If a touch event sensed at a mapped region of the ‘Cheon’ 1410 is moved to a right direction, the controller 120 displays a ‘ [symbol] (a)’ 1413 on the display unit 133. Further, if a touch event is vertically moved in a displayed state of a ‘ [symbol] (a)’ 1413, the controller 120 displays a ‘ [symbol] (ae)’ 1415 on the display unit 133. If the touch event is again moved to a left direction in a displayed state of a ‘ [symbol] (a)’ 1413, the controller 120 displays a ‘ [symbol] (ya)’ 1417 on the display unit 133. Further, if the touch event is vertically moved in a displayed state of a ‘ [symbol] (ya)’ 1417, the controller 120 displays a ‘ [symbol] (yae)’ 1419 on the display unit 133.

There is a method using rotation of a touch event as an example of a method for changing a ‘Cheon’ 1410 to a ‘ [symbol] (ya)’ 1417 having two horizontal right extending strokes. That is, if a touch event sensed at a mapped region of a ‘Cheon’ 1410 is moved to a clockwise rotation direction, the controller 120 displays a ‘ [symbol] (ya)’ 1417 on the display unit 133. If a touch event is moved upwards in a mapped region of a ‘Cheon’ 1410, the controller 120 displays a ‘ [symbol] (o)’ 1420 on the display unit 133. If the touch event is mover downwards in the displayed state of the ‘ [symbol] (o)’ 1420, the controller 120 displays a ‘ [symbol] (yo)’ 1423 on the display unit 133. In this case, there is a method using rotation of a touch event as an example of a method for changing a ‘Cheon’ 1410 to a ‘ [symbol] (yo)’ 1423 having two upward extending strokes. If a touch event sensed in a mapped region of a ‘Cheon’ 1410 is moved to an upward rotation direction, the controller 120 displays a ‘ [symbol] (yo)’ 1423 on the display unit 133.

If the touch event is vertically moved after change of a moving direction while moving in a diagonal direction in a displayed state of a ‘ [symbol] (o)’ 1420, the controller 120 displays a ‘ [symbol] (oe)’ 1425 on the display unit 133. If the touch event is horizontally moved in a displayed state of a ‘ [symbol] (oe)’ 1425, the controller 120 displays a ‘ [symbol] (wa)’ 1427 on the display unit 133. If the touch event is vertically moved in a displayed state of a ‘ [symbol] (wa)’ 1427, the controller 120 displays a ‘ [symbol] (wae)’ 1429 on the display unit 133. If the touch event is horizontally moved in a displayed state of a ‘ [symbol] (o)’ 1420 in an input scheme of a ‘ [symbol] (wa)’ 1427, the controller 120 may display a ‘ [symbol] (wa)’ 1427 on the display unit 133.

If the touch event sensed at a mapped region of a ‘Cheon’ 1410 is moved to a left direction, the controller 120 displays a ‘ [symbol] (eo)’ 1430 on the display unit 133. If the touch event is vertically moved in a displayed state of a ‘ [symbol] (eo)’ 1430, the controller 120 displays a ‘ [symbol] (e)’ 1433 on the display unit 133. If the touch event is again moved to a right direction in a displayed state of a ‘ [symbol] (eo)’ 1430, the controller 120 displays a ‘ [symbol] (yeo)’ 1435 on the display unit 133. Further, if the touch event is vertically moved in a displayed state of a ‘ [symbol] (yeo)’ 1435, the controller 120 displays a ‘ [symbol] (ye)’ 1437 on the display unit 133.

There is a method using rotation of a touch event as an example of a method for changing a ‘Cheon’ 1430 to a ‘ [symbol] (yeo)’ 1435 having two horizontal left extending strokes. That is, if a touch event sensed at a mapped region of a ‘Cheon’ 1410 is moved to a left counterclockwise rotation, the controller 120 displays a ‘ [symbol] (yeo)’ 1435 on the display unit 133.

If a touch event is moved downwards in a mapped region of a ‘Cheon’ 1410, the controller 120 displays a ‘ [symbol] (u)’ 1450 on the display unit 133. If the touch event is moved upwards in a displayed state of the ‘ [symbol] (u)’ 1450, the controller 120 displays a ‘ [symbol] (u)’ 1453 on the display unit 133. In this case, there is a method using rotation of a touch event as an example of a method for changing a ‘Cheon’ 1410 to a ‘ [symbol] (u)’ 1453 having two downward extending strokes. That is, if a touch event sensed at a mapped region of a ‘Cheon’ 1410 is moved a downward rotation direction, the controller 120 displays a ‘ [symbol] (u)’ 1453 on the display unit 133.

If the touch event is vertically move after change of a moving direction while moving in a diagonal direction in a displayed state of a ‘ [symbol] (u)’ 1450, the controller 120 displays a ‘ [symbol] (wi)’ 1455 on the display unit 133. If the touch event is horizontally moved in a displayed state of a ‘ [symbol] (wi)’ 1455, the controller 120 displays a ‘ [symbol] (wo)’ 1457 on the display unit 133. If the touch event is vertically moved in a displayed state of a ‘ [symbol] (wo)’ 1457, the controller 120 displays a ‘ [symbol] (we)’ 1459 on the display unit 133.

In this case, if a touch event is horizontally moved in a displayed state of a ‘ [symbol] (u)’ 1450 in an input scheme of a ‘ [symbol] (wo)’ 1457, the controller 120 may display a ‘ [symbol] (wo)’ 1457 on the display unit 133.

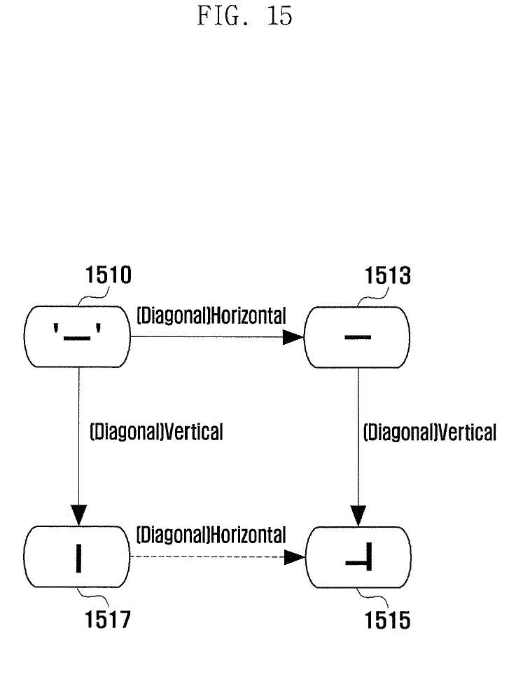

FIG. 15 illustrates vowels input according to a touch event based on a second cardinal vowel according to a second embodiment of the present disclosure. In this case, it is assumed that a touch event is sensed at a region to which a cardinal vowel ‘Ji’ is allotted.

Referring to FIG. 15, a controller 120 confirms a ‘Ji’ 1510 mapped to a sensed region of a touch event. If a touch event is horizontally moved after change of a moving direction while moving in a diagonal direction, the controller 120 displays a ‘-(eu)’ 1513 on the display unit 133. If the touch event is vertically moved after change of a moving direction while moving in a diagonal direction, the controller 120 displays a ‘ [symbol] (ui)’ 1515 on the display unit 133. If the touch event is vertically moved after change of a moving direction while moving in a diagonal direction, the controller 120 displays a ‘|(i)’ 1517 on the display unit 133. If the touch event is horizontally moved after change of a moving direction while moving in a diagonal direction, the controller 120 may display a ‘ [symbol] (ui)’ 1515.

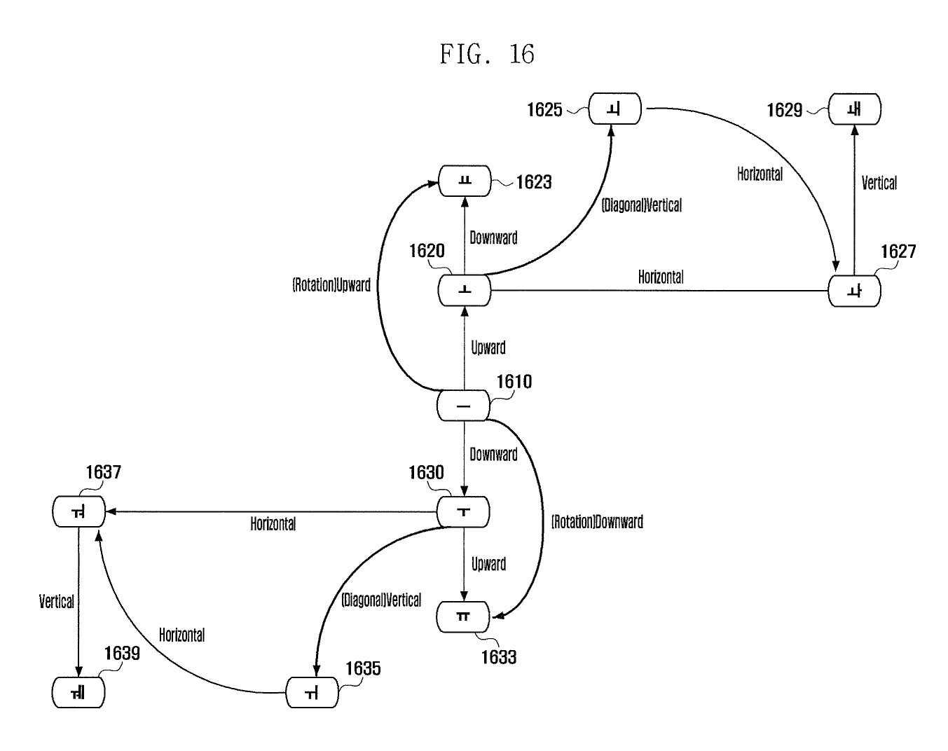

FIG. 16 illustrate vowels input according to a moving direction of a touch event in a ‘-(eu)’ 1513 state of FIG. 15 or in a touched state of a ‘-(eu)’ key on a key pad based on a second cardinal vowel according to a third embodiment of the present disclosure.

Referring to FIG. 16, if a touch event is moved upwards in a mapped region of a ‘Ji (-(eu))’ 1610, the controller 120 displays a ‘ [symbol] (o)’ 1620 on the display unit 133. If the touch event is moved downwards in a displayed state of a ‘ [symbol] (o)’ 1620, the controller 120 displays a ‘ [symbol] (yo)’ 1623 on the display unit 133. There is a method using rotation of a touch event as an example of a method for changing a ‘Ji(-(eu))’ 1610 to a ‘ [symbol] (yo)’ 1623 having two upward extending strokes. That is, if a touch event sensed at a mapped region of a ‘Ji (-(eu))’ 1610, the controller 120 displays a ‘ [symbol] (yo)’ 1623 on the display unit 133.

If a touch event is vertically moved after change of a moving direction while moving in a diagonal direction in a displayed state of a ‘ [symbol] (o)’ 1620, the controller 120 displays a ‘ [symbol] (oe)’ 1625 on the display unit 133. If the touch event is horizontally moved in a displayed state of a ‘ [symbol] (oe)’ 1625, the controller 120 displays a ‘ [symbol] (wa)’ 1627 on the display unit 133. If the touch event is vertically moved in a displayed state of a ‘ [symbol] (wa)’ 1627, the controller 120 displays a ‘ [symbol] (wae)’ 1629 on the display unit 133. In this case, if the touch event is horizontally moved in a displayed state of a ‘ [symbol] (o)’ 1620 in an input scheme of a ‘ [symbol] (wa)’ 1627, the controller 120 may display a ‘ [symbol] (wa)’ 1627 on the display unit 133.

If a touch event is moved downwards in a mapped region of a ‘Ji’ 1610, the controller 120 displays a ‘ [symbol] (u)’ 1630 on the display unit 133. Further, if the touch event is moved upwards in a displayed state of a ‘ [symbol] (u)’ 1630, the controller a ‘ [symbol] (u)’ 1633 on the display unit 133. In this case, there is a method using rotation of a touch event as an example of a method for changing a ‘Ji’ 1410 to a ‘ [symbol] (u)’ 1633 having two downward extending strokes. That is, if a touch event sensed in a mapped region of a ‘Ji’ 1610 is moved in a downward rotation direction, the controller 120 displays a ‘ [symbol] (u)’ 1633 on the display unit 133.

If the touch event is vertically mover after change of a moving direction while moving in a diagonal direction, the controller 120 displays a ‘ [symbol] (wi)’ 1635 on the display unit 133. If the touch event is horizontally moved in a displayed state of a ‘ [symbol] (wi)’ 1635, the controller 120 displays a ‘ [symbol] (wo)’ 1637 on the display unit 133. If the touch event is vertically moved in a displayed state of a ‘ [symbol] (wo)’ 1637, the controller 120 displays a ‘ [symbol] (we)’ 1639 on the display unit 133. In this case, if the touch event is horizontally moved in an input scheme of a ‘ [symbol] (wo)’ 1637 in a displayed state of a ‘ [symbol] (u)’ 1630, the controller 120 may display a ‘ [symbol] (wo)’ 1377 on the display unit 133.

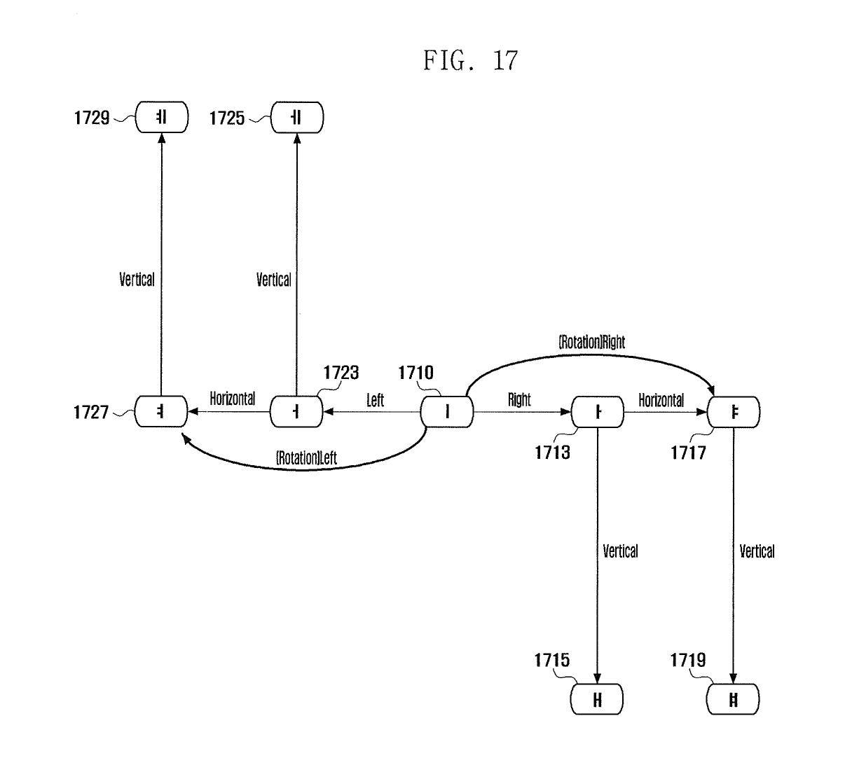

FIG. 17 is a view illustrating vowels input according to a moving direction of a touch event in a ‘|(i)’ 1517 state of FIG. 15 or in a touched state of a ‘|(i)’ key on a key pad based on a third cardinal vowel according to a third embodiment of the present disclosure.

Referring to FIG. 17, if a touch event sensed at a mapped region of a ‘Ji (-(eu))’ 1710 is moved to a right direction, the controller 120 displays a ‘ [symbol] (a)’ 1713 on the display unit 133. Further, if the touch event is vertically moved in a displayed state of a ‘ [symbol] (a)’ 1713, the controller 120 displays a ‘ [symbol] (ae)’ 1715 on the display unit 133. If the touch event is again moved horizontally in a displayed state of a ‘ [symbol] (a)’ 1713, the controller 120 displays a ‘ [symbol] (ya)’ 1717 on the display unit 133. If the touch event is vertically moved in a displayed state of a ‘ [symbol] (ya)’ 1717, the controller 120 displays a ‘ [symbol] (yae)’ 1719 on the display unit 133.

There is a method using rotation of a touch event as an example of a method for changing a ‘Ji’ 1710 to a ‘ [symbol] (ya)’ 1717 having two horizontal right extending strokes. That is, if the touch event sensed at a mapped region of a ‘Ji (-(eu))’ 1710 is moved to a clockwise rotation direction, the controller 120 displays a ‘ [symbol] (ya)’ 1717 on the display unit 133.

If the touch event sensed in a mapped region of a ‘Ji (-(eu))’ 1710 is moved to a left direction, the controller 120 displays a ‘ [symbol] (eo)’ 1723 on the display unit 133. If the touch event is vertically moved in a displayed state of a ‘ [symbol] (eo)’ 1723, the controller 120 displays a ‘ [symbol] (e)’ 1725 on the display unit 133. If the touch event is again moved horizontally in a displayed state of a ‘ [symbol] (eo)’ 1723, the controller 120 displays ‘ [symbol] (yeo)’ 1727 on the display unit 133. Further, if the touch event is vertically moved in a displayed state of a ‘ [symbol] (yeo)’ 1727, the controller 120 displays a ‘ [symbol] (ye)’ 1729 on the display unit 133.

There is a method using rotation of a touch event as an example of a method for changing a ‘Ji’ 1710 to a ‘ [symbol] (yeo)’ 1727 having two horizontal left extending strokes. That is, if a touch event sensed at a mapped region of a ‘Ji’ 1710, the controller 120 displays a ‘ [symbol] (yeo)’ 1727 on the display unit 133.

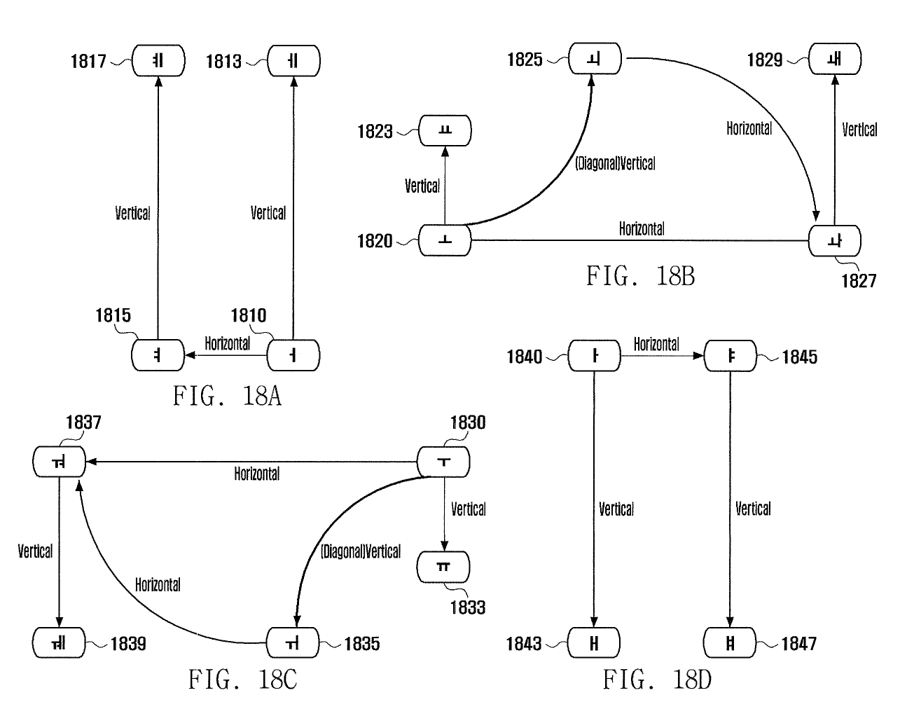

FIGS. 18A-18D illustrate vowels input according to a moving direction of a touch event by vowels according to a third embodiment of the present disclosure.

Referring to FIG. 18A, it is assumed that a vowel ‘ [symbol] (eo)’ 1810 is displayed on the display unit 133. If the sensed touch event is vertically moved, the controller 120 displays a ‘ [symbol] (e)’ 1813 on the display unit 133. If the touch event is again moved horizontally in a displayed state of a ‘ [symbol] (eo)’ 1810, the controller 120 displays a ‘ [symbol] (yeo)’ 1815 on the display unit 133. Further, if the touch event is vertically moved in a displayed state of a ‘ [symbol] (yeo)’ 1815, the controller 120 displays a ‘ [symbol] (ye)’ 1817 on the display unit 133.

Referring to FIG. 18B, it is assumed that a vowel ‘ [symbol] (o)’ 1820 is displayed on the display unit 133. If the sensed touch event is vertically moved, the controller 120 displays a ‘ [symbol] (yo)’ 1823 on the display unit 133. If the touch event sensed in a displayed state of the ‘ [symbol] (u)’ 1830 is vertically moved, the controller 120 displays a ‘ [symbol] (u)’ 1833 on the display unit 133.

If the touch event sensed in a displayed state of the ‘ [symbol] (u)’ 1830 is again moved vertically after change of a moving direction while moving in a diagonal direction, the controller 120 displays a ‘ [symbol] (wi)’ 1835 on the display unit 133. If the touch event is horizontally moved in a displayed state of a ‘ [symbol] (wi)’ 1835, the controller 120 displays a ‘ [symbol] (wo)’ 1837 on the display unit 133. If the touch event is vertically moved in a displayed state of a ‘ [symbol] (wo)’ 1837, the controller 120 displays a ‘ [symbol] (we)’ 1839 on the display unit 133. In this case, if the touch event is horizontally moved in an input scheme of a ‘ [symbol] (wo)’ 1837 in a displayed state of a ‘ [symbol] (u)’ 1830, the controller 120 may display the ‘ [symbol] (wo)’ 1837 on the display unit 133.

Referring to FIG. 18D, it is assumed that a vowel ‘ [symbol] (a)’ 1840 is displayed on the display unit 133. If the sensed touch event is vertically moved, the controller 120 displays a ‘ [symbol] (ae)’ 1843 on the display unit 133. If the touch event is again moved horizontally in a displayed state of the ‘ [symbol] (a)’ 1840, the controller 120 displays a ‘ [symbol] (ya)’ 1845 on the display unit 133. Moreover, if the touch event is vertically moved in a displayed state of a ‘ [symbol] (ya)’ 1845, the controller 120 displays a ‘ [symbol] (yae)’ 1847 on the display unit 133.

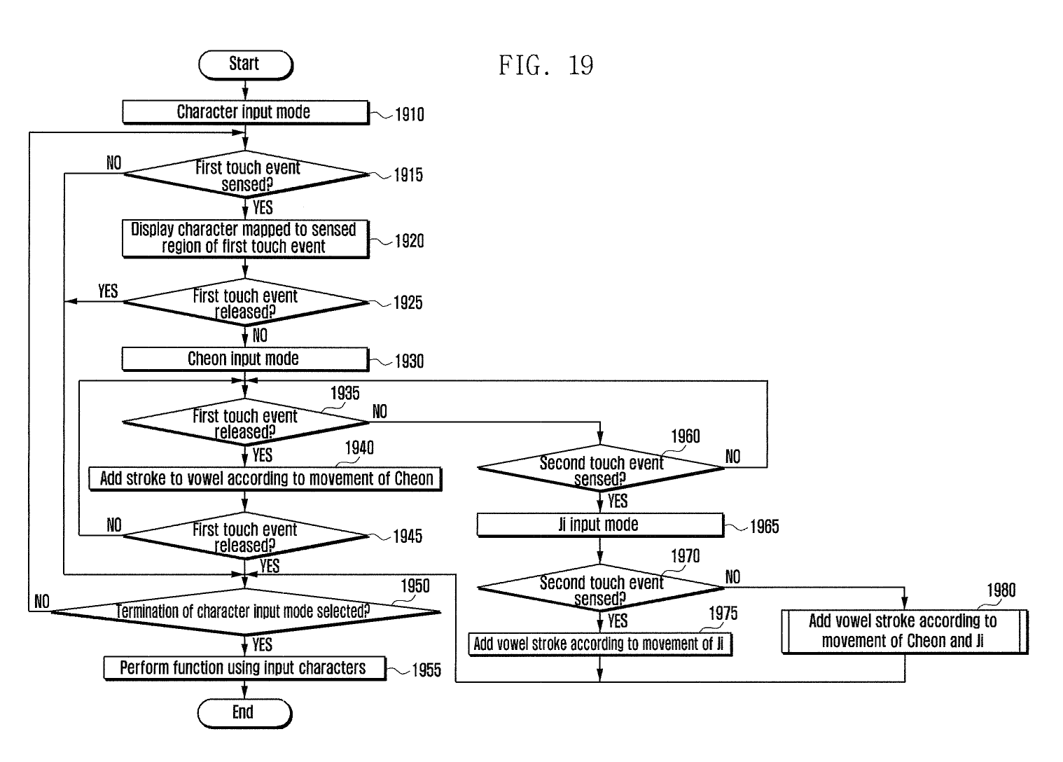

FIG. 19 illustrates a Hanguel input method according to an embodiment of the present disclosure.

Referring to FIG. 19, a controller 120 performs a character input mode according to selection of a user 1910. In this case, the character input mode means a message transmission function capable of transmitting messages, a user schedule management function such as memo or schedule, and a document creation function capable of creating documents. Next, the controller 120 determines whether a first touch event is sensed through a touch screen 130 1915. If the first touch event is sensed, the controller 120 checks a region in which the first touch event is sensed 1920. Further, the controller 120 displays a character mapped to the checked region on the touch screen 130.

Subsequently, the controller 120 determines whether the first touch event is released 1925. If the first touch event is not released, the controller 120 changes a terminal to a Cheon input mode 1930. In this case, the Cheon input mode means a mode of recognizing that a cardinal vowel Cheon is mapped to a current sensed region of a first touch event and displays a vowel using a Cheon according to movement of the touch event. The controller 120 determines whether the first touch event is moved 1935. If the first touch event is moved, the controller 120 controls a touch screen 130 to add a stroke to a vowel according to movement of a Cheon and display the added vowel 1940. Then, the controller 120 determines whether a first touch event is released 1945. If the first touch event is released, the controller 120 determines whether termination of a character input mode is selected 1950. If the terminal of the character input mode is selected, the controller 120 performs a function using input characters 1955. For example, if a character input mode corresponds to a message transmission function, the controller 120 terminates character input and then transmits messages. If the character input mode corresponds to a document creation function, the controller 120 terminates character input and then stores created characters in the memory 110.

If the first touch event is not moved at step 1935, the controller 120 determines whether the second touch event is sensed 1960. It is preferred that the second touch event is sensed at one of remaining regions except for sensed regions of the first touch event on the touch screen 130. If the second touch event is sensed, the controller 120 changes the terminal to a Ji input mode 1965. In other words, the controller 120 recognizes that a Ji being a cardinal vowel is mapped to a sensed region of the second touch event, and changes a character input mode to a Ji input mode capable of inputting vowels according to movement of the Ji.

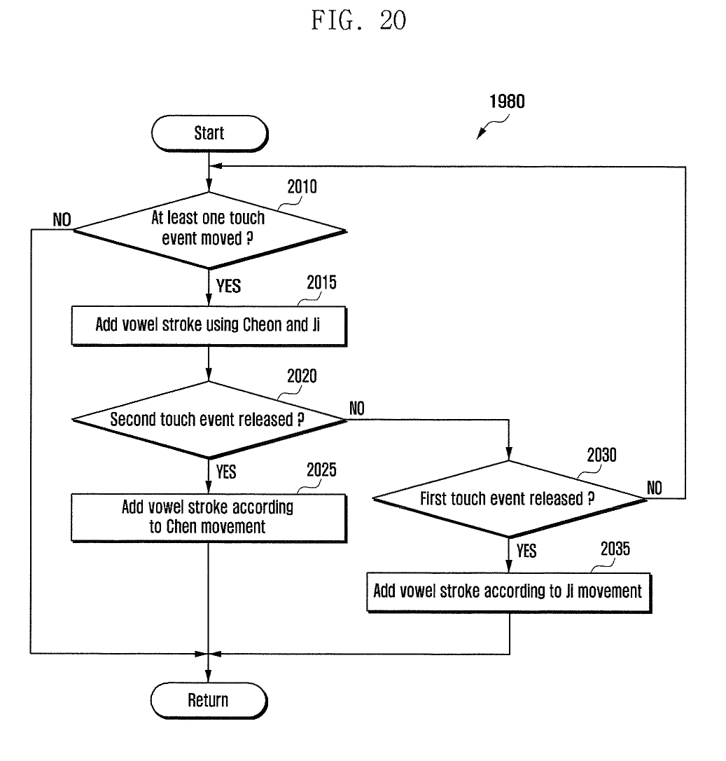

Further, the controller 120 determines whether a second touch event is moved through the touch screen 130 1970. If movement of the second touch event is sensed, the controller 120 adds vowel stroke according to movement of a Ji 1975. Conversely, if the movement of the second touch event is not sensed, the controller 120 adds vowel stroke according to movement of a Cheon and a Ji 1980. In this case, step 1980 will be described with reference to FIG. 20.

FIG. 20 illustrates a method for inputting vowels according to movement of two touch event according to an embodiment of the present disclosure.

Referring to FIG. 20, a controller 120 determines whether movement of at least one touch event is sensed through a touch screen 130 2010. If the movement of at least one touch event is sensed, the controller 120 adds vowel stroke using a Cheon and a Ji according to movement of a touch event 2015. That is, the controller 120 adds vowel stroke according to movement of Cheon if a first touch event is moved, adds vowel stroke according to movement of Ji if a second touch event is moved, and adds vowel stroke using Cheon and Ji according to movement of the first and second touch events.

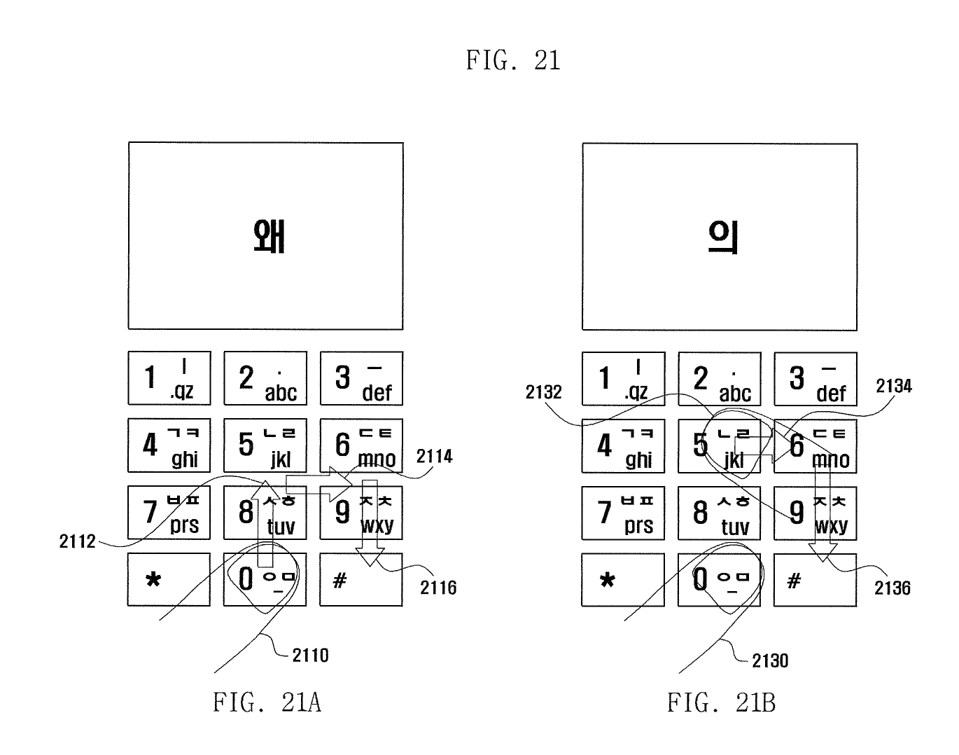

FIGS. 21A-B illustrate a first example of a method for inputting characters according to an embodiment of the present disclosure.

Referring to FIG. 21, in an embodiment of the present disclosure, a method for inputting characters ‘ [symbol] (ngwae)’ and ‘ [symbol] (ngui)’ will be described. FIG. 21A illustrates a method for inputting a character ‘ [symbol] (ngwae)’. FIG. 21B illustrates a method for inputting a character ‘ [symbol] (ngwae)’.

Referring to FIG. 21A, a user touches a displayed region of a consonant ‘◯(ng)’ to input a character ‘ [symbol] (ngwae)’ 2110. Accordingly, the controller 120 displays a consonant ‘◯(ng) ’ mapped to a sensed region of a touch event. Further, the user continuously moves a touch in three directions 2112, 2114, 2116 to input a vowel without releasing the touch. Accordingly, the controller 120 displays a vowel according to a moving direction of a touch event sensed through the touch screen 130. In detail, if first movement 2112 of a touch event is sensed through a touch screen 130, the controller 120 checks a moving direction. In this case, the first moving direction is an upward direction. Accordingly, the controller 120 adds a vowel ‘ [symbol] (o)’ to display a character ‘ [symbol] (ngo)’. Further, the controller 120 checks a second moving direction 2114 sensed through the touch screen 130. Because the second moving direction is a horizontal direction, the controller 120 adds a vowel ‘ [symbol] (a)’ to display a character ‘ [symbol] (nga)’. Next, the controller 120 checks a third moving direction 2116 through the touch screen 130. Because the third moving direction is a vertical direction, the controller 120 adds a vowel ‘|(i)’ to display a character ‘ [symbol] (ngwae)’.

Referring to FIG. 21B, the user firstly touches a consonant ‘◯(ng)’ to input a character ‘ [symbol] (ngui)’ 2130. Further, the user secondly touches some region of a touch screen 130 in a touched state of a region on which a consonant ‘◯(ng)’ is displayed 2132. Subsequently, the user moves a second touch in two directions 2134, 2136 to input a vowel. Accordingly, the controller 120 displays a consonant ‘◯(ng)’ of a region in which a first touch event 2130 is sensed through the touch screen 130. Then, the controller 120 displays a character according to a moving direction of the second touch event 2132. That is, the controller 120 checks that a first moving direction of the second touch event 2132 is a horizontal direction 2134, and adds a vowel ‘-(eu)’ to display a character ‘ [symbol] (ngeu)’. Further, the controller 120 checks that a second moving direction of the second touch event is a vertical direction 2136, and adds a vowel ‘|(i)’ to display a character ‘ [symbol] (ngui)’.

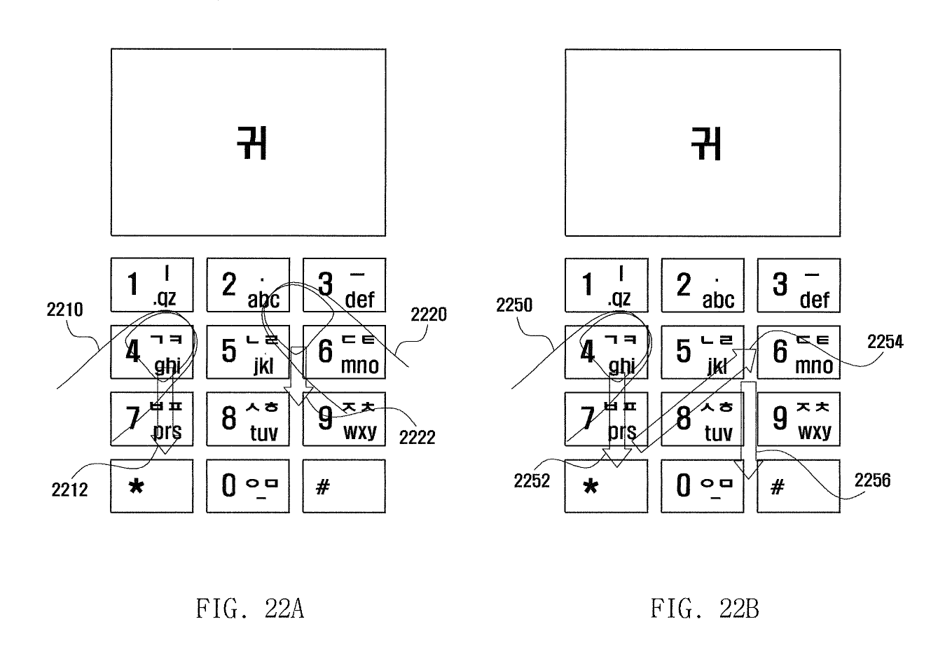

FIGS. 22A-22B illustrate a second example of a method for inputting characters according to an embodiment of the present disclosure. More particularly, FIGS. 22A and 22B illustrate an example of a method for displaying a character ‘ [symbol] (gwi)’ using two vowel input methods.

FIG. 22A illustrates an example of a method for inputting a character using two touch events. The user firstly touches a displayed region of a consonant ‘ [symbol] (g)’ to input a character ‘ [symbol] (gwi)’ 2210. The user secondly touches some region of a touch screen 130 to input a vowel 2220. Next, the user moves a first touch and a second touch to input a vowel 2212, 2222. Accordingly, the controller 120 displays a consonant ‘ [symbol] (g)’ mapped to a sensed region of a first touch event. Next, the controller 120 displays a character ‘ [symbol] (gwi)’ according to movement of the first touch event and the second touch event sensed through the touch screen 130.

FIG. 22B illustrates an example of a method for inputting a character using one touch event. The user touches a sensed region of a consonant ‘ [symbol] (g)’ to input a character ‘ [symbol] (gwi)’ 2250. The user continuously moves a touch in two directions to input a vowel without releasing the touch. Accordingly, the controller 120 displays a consonant ‘ [symbol] (g)’ at a sensed region of a first touch through the touch screen 130. Further, the controller 120 checks a moving direction of a touch to display a vowel. That is, if a first moving direction of the touch event 2250 is a downward direction 2252, the controller 120 adds a vowel ‘ [symbol] (u)’ to display a character ‘ [symbol] (gu)’. Further, if a second moving direction of a next touch event 2250 is a diagonal direction 2254, the controller 120 determines that it is to input a vowel ‘|(i)’ or ‘-(eu)’. Finally, a third moving direction of the touch event is a vertical direction 2256, the controller 120 adds a vowel ‘|(i)’ to display a character ‘ [symbol] (gwi)’. The foregoing embodiment has a method for inputting Hanguel in a terminal. The present disclosure is applicable to various languages the word of which is composed of consonants and vowels. Among them, methods for inputting English and Chinese languages according to the present disclosure will be described.

The English language is configured by 26 alphabets, and a, e, i, o, u of them are used as a vowel. Accordingly, vowels to input are previously set according to a moving direction of a touch event by the user or a terminal manufacturing company, and a corresponding vowel may be input according to a moving direction of a sensed touch event.

In a case of Chinese language, hundred thousand Chinese letters are used as a character. Chinese pinyin is used to input Chinese letters. The Chinese pinyin means a pronouncing symbol that indicates pronunciation of Chinese letters as Roman letters, and is composed of 21 Chinese consonants and 36 Chinese vowels. The Chinese consonant is a consonant of a syllable, and the Chinese vowel indicates a vowel combined with consonants of syllable or an available vowel in the syllable without consonant. Pronunciation of various Chinese letters may be indicated by a combination of a Chinese consonant and at least one vowel or a plurality of vowels such as a combined vowel. A method for inputting Chinese letters will be described by using a, e, i, o, u as examples of Chinese vowels.

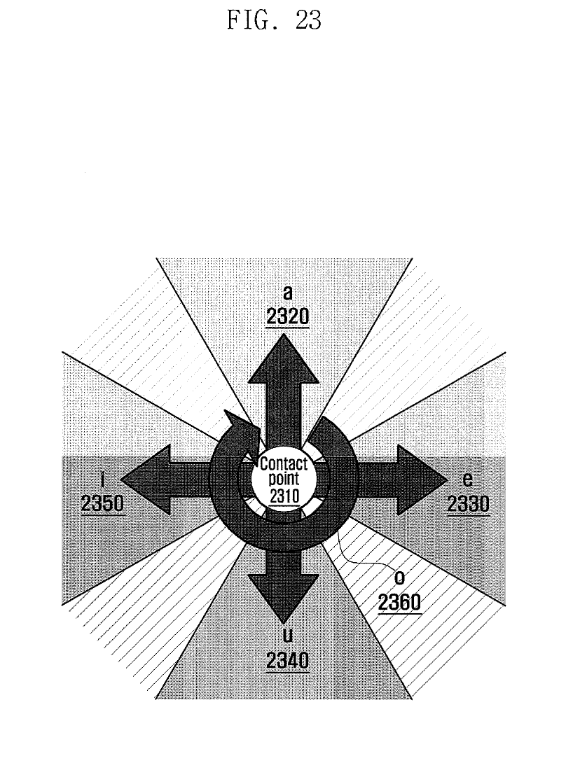

FIG. 23 is a view illustrating vowels input according to a moving direction of a touch event according to an embodiment of the present disclosure.

Referring to FIG. 23, the controller 120 may determine a moving direction of a touch event based on a contact point 2310 which is a sensed region of a touch event. That is, the controller 120 may determine an upward 2330 direction, a right 2330 direction, a downward 2340 direction, a left 2350 direction, and a rotation 2360. Further, the controller 120 may display a vowel corresponding to a moving direction of a touch event.

For example, it is assumed that coordinates of a contact point 210 are (0, 0). If moved coordinates of the touch event are (0, +n), the controller 120 determines the moving direction of the touch event as an upward 2320 direction. Further, if moved coordinates of the touch event are (+n, 0), the controller 120 determines the moving direction of the touch event as a right 2330 direction. If moved coordinates of the touch event are (0, −n), the controller 120 determines the moving direction of the touch event as a downward 2340 direction. Furthermore, if moved coordinates of the touch event are (−n, 0), the controller 120 determines a moving direction of the touch event as a left 2350 direction. Finally, coordinates (0, 0) sensed when movement of the touch event stops is similar to (0, 0), the controller 120 determines a moving direction of the touch event as a rotation 2360.

In this case, an n is an optional number indicating coordinates. Coordinates are suggested to determine a moving direction, which are used to easily describe a moving direction. However, the present disclosure is not limited thereto. That is, coordinates set to sense each moving direction may be changed by a manufacturing company of a terminal or selection of the user.

Vowel mapping information by directions being information about vowels displayed according to a moving direction of a touch event may be set by the user or a manufacturing company of a terminal. That is, a vowel a is set at an upward 2320 direction based on a contact point 2310 as vowel mapping information by directions. A vowel e, a vowel u, a vowel i, and a vowel o may be set at a right 2330 direction, a downward 2340 direction, a left 2350 direction, and a rotation 2360 as the vowel mapping information by directions. Accordingly, the controller 120 may confirm a moving direction of a touch event sensed using vowel mapping information by directions, and confirm a vowel according to the confirmed moving direction to display a corresponding vowel.

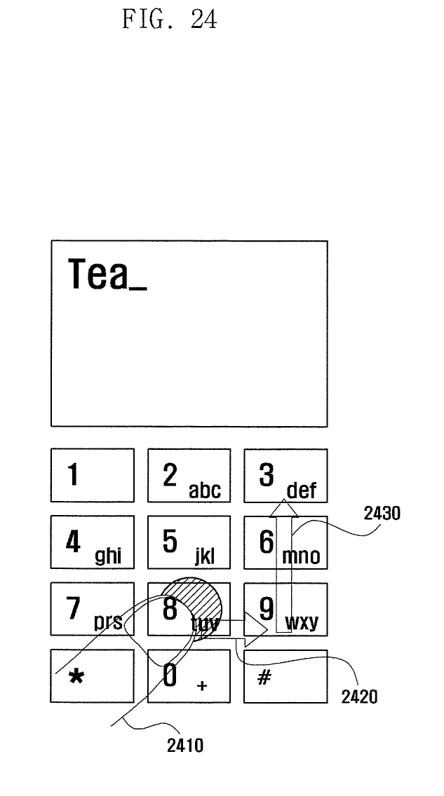

FIG. 24 is a view illustrating a third example of a method for inputting characters according to an embodiment of the present disclosure.

Referring to FIG. 24, the user touches a displayed region of a consonant ‘T’ to input English letter ‘Tea’ (2410) . Accordingly, the controller 120 displays a consonant ‘T’ mapped to a sensed region of a touch event. Further, the user continuously moves the touch in two directions 2420 and 2430 to input a vowel without releasing the touch. Accordingly, the controller 120 displays a vowel according to a moving direction of a touch event sensed through the touch screen 130.

In detail, if a first movement 2420 of the touch event is sensed through the touch screen 130, the controller 120 confirms a moving direction. In this case, the first moving direction is a right direction. Accordingly, the controller 120 adds a vowel ‘e’ to display a character ‘Te’. Further, the controller 120 confirms a moving direction 2430 sensed through the touch screen 130. Because the second moving direction is an upward direction, the controller 120 adds a vowel ‘a’ to display a character ‘Tea’.

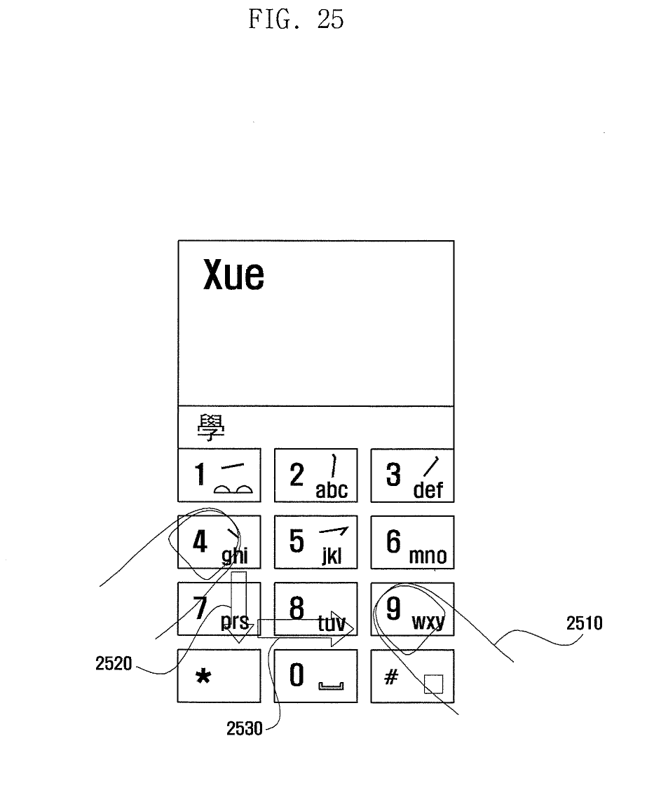

FIG. 25 is a view illustrating a fourth example of a method for inputting characters according to an embodiment of the present disclosure.

Referring to FIG. 25, the user firstly touches a displayed region of a Chinese consonant ‘X’ to input a Chinese pinyin ‘Xue’ corresponding to Chinese letter ‘ [symbol] ’ (2510). Accordingly, the controller 120 displays Chinese consonant ‘X’ mapped to a sensed region of a first touch event. Further, the user secondly touches some region of the touch screen 130 to input a vowel. Next, the user moves the second touch for inputting Chinese vowel (2520, 2530). It is assumed that a vowel input according to a moving direction of the touch event is set as illustrated in FIG. 23.

If a first movement 2520 of a second touch event is sensed through the touch screen 130, the controller 120 confirms a moving direction. In this case, the first moving direction is a downward direction. Accordingly, the controller 120 adds Chinese vowel ‘u’ to display Chinese pinyin ‘Xu’. Further, the controller 120 confirms a second moving direction 2530 sensed through the touch screen 130. Because the second moving direction is a right direction, the controller 120 adds Chinese vowel ‘e’ to display Chinese pinyin ‘Xue’. In this case, the controller 120 simultaneously displays Chinese letter ‘ [symbol] ’ corresponding to the Chinese pinyin ‘Xue’ . If the Chinese ‘ [symbol] ’ displayed by the user is selected, the controller 120 display the Chinese letter ‘ [symbol] ’ instead of the Chinese pinyin ‘Xue’.

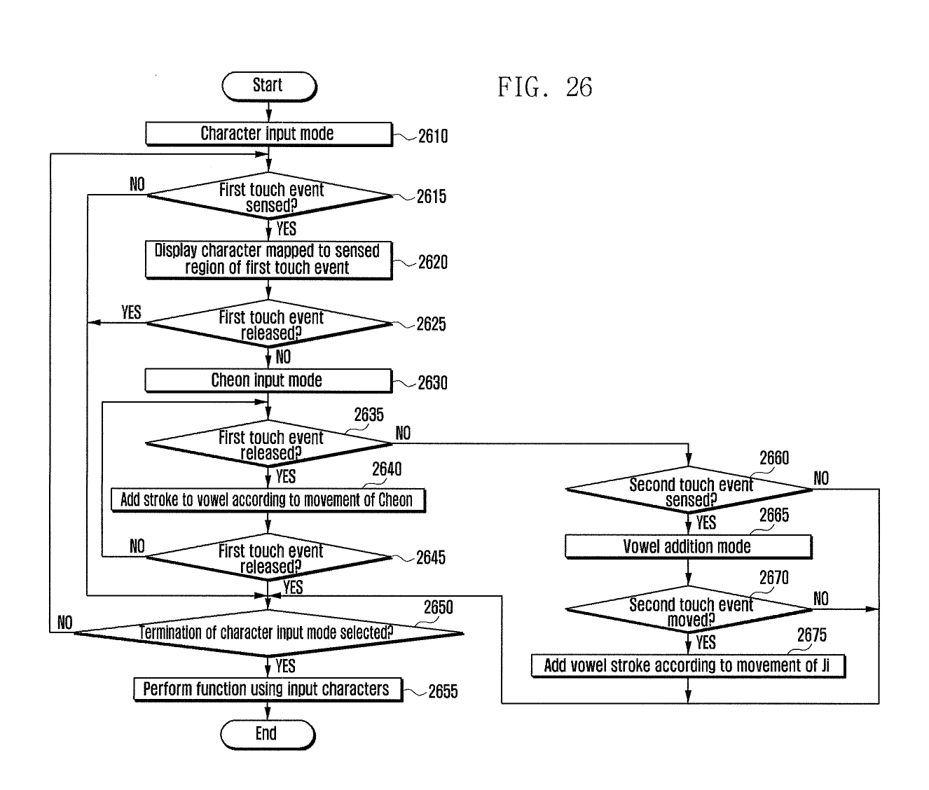

FIG. 26 is a flowchart illustrating a character input method according to an embodiment of the present disclosure.

Referring to FIG. 26, a controller 120 performs a character input mode according to selection of a user 2610. In this case, the character input mode means a mode input in English or Chinese instead of Hanguel, which is a mode a character message creation mode, a document creation mode for performing a function using a character. Next, the controller 120 determines whether a first touch event is sensed through a touch screen 130 2615.

If the first touch event is sensed, the controller 120 checks a region in which the first touch event is sensed 2620. Further, the controller 120 displays a character mapped to the checked region on the touch screen 130. Subsequently, the controller 120 determines whether the first touch event is released 2625.

If the first touch event is not released, the controller 120 changes a terminal to a Cheon input mode 2630. In this case, the vowel input mode means a mode for inputting a vowel according to a moving direction of the touch event. Further, the controller 120 determines whether a first touch event is moved through a touch screen 130 2635.

If the first touch event is moved, the controller 120 controls a touch screen 130 to confirm a moving direction of a first touch event, and to display a vowel according to the confirmed moving direction 2640. Then, the controller 120 determines whether a first touch event is released 2645. If the first touch event is released, the controller 120 determines whether termination of a character input mode is selected 2650. If the terminal of the character input mode is selected, the controller 120 performs a function using input characters 2655. For example, if a character input mode corresponds to a message transmission function, the controller 120 terminates character input and then transmits messages. If the character input mode corresponds to a document creation function, the controller 120 terminates character input and then stores created characters in the memory 110.

If the first touch event is not moved at step 2635, the controller 120 determines whether the second touch event is sensed 2660. It is preferred that the second touch event is sensed at one of remaining regions except for sensed regions of the first touch event on the touch screen 130.

If the second touch event is sensed, the controller 120 changes the terminal to a vowel addition mode 2665. Accordingly, the controller 120 may additionally input a vowel except for vowels input according to movement of the first touch event. Further, the controller 120 determines whether a second touch event is moved through the touch screen 130 2670. If movement of the second touch event is sensed, the controller 120 adds vowels according to a moving direction of the second event 2675.

In the present disclosure, a terminal having a touch screen may input vowels through a moving direction of a touch event. Accordingly, the user may intuitively input desired vowels. Further, the vowels may be input through various touch events. Accordingly, the user may conveniently input vowels using various input schemes.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A character input method in a terminal having a touch screen, the method comprising:
checking and displaying a character mapped to a sensed region of a first touch event when the first touch event is sensed in a character input mode, and determining whether the first touch event is released;
determining whether the first touch event is moved when the first touch event is not released; and
confirming a moving direction of the first touch event and adding a vowel to display a character when the first touch event is moved.

2. The method of claim 1, wherein determining whether the first touch event is moved comprises:
determining whether a second touch event is sensed.

3. The method of claim 2, further comprising:
determining at least one of the first touch event and the second touch event is moved when the second touch event is sensed; and
displaying a vowel according to the moved touch event.

4. The method of claim 3, wherein displaying a vowel comprises determining whether a moving direction of at least one of the first touch event and the second touch event is a diagonal direction to display the vowel.

5. The method of claim 4, wherein displaying the vowel comprising displaying a vowel ‘|(i)’ or ‘-(eu)’ when the moving direction is a diagonal direction.

6. The method of claim 3, wherein displaying a vowel comprises adding a stroke to a vowel to display the added vowel according to a moving direction of the at least one touch event when a moving direction of the touch event is not the diagonal direction.

7. The method of claim 1, wherein the moving direction of the touch event is at least one of an upward direction, a downward direction, a left direction, a right direction, a rotation direction, a horizontal direction, and a vertical direction.

8. A character input terminal comprising;
a touch screen including a touch sensor and a display unit, the touch sensor configured to sense a touch event and the display unit configured to display a vowel according to a moving direction of the touch event;
a memory configured to store vowel mapping information by directions to display the vowel according to the moving direction of the touch event; and
a controller configured to confirm and display a character mapped to a sensed region of a first touch event when the first touch event is sensed through the touch screen in a character input mode, determine whether the first touch event is moved when the first touch event is not released, confirm a moving direction of the first touch event when the touch event is moved, and add a vowel according to the moving direction to the vowel mapping information by directions to display the added vowel mapping information on the display unit.

9. The character input terminal of claim 8, wherein the controller determines whether a second touch event is sensed through the touch screen, determining whether at least one of the first touch event and the second touch event is moved when the second touch event is sensed, and displays a vowel according to the moved touch event.

10. The character input terminal of claim 9, wherein the controller determines whether a moving direction of at least one of the first touch event and the second touch event is a diagonal direction to display the vowel.

11. The character input terminal of claim 8, wherein the moving direction of the touch event is at least one of an upward direction, a downward direction, a left direction, a right direction, a rotation direction, a horizontal direction, and a vertical direction.

12. The character input terminal of claim 8, wherein the controller adds a stroke to a vowel to display the added vowel according to a moving direction of the at least one touch event when a moving direction of the touch event is not the diagonal direction.

13. The character input terminal of claim 8, wherein the controller displays a vowel ‘|(i)’ or ‘-(eu)’ when the moving direction is a diagonal direction.

14. An apparatus capable of determining a character input for use in a portable terminal, the apparatus comprising;
a touch screen comprising a touch sensor and a display unit, the touch screen configured to sense a touch event and the display unit configured to display a vowel according to a moving direction of the touch event;
a memory configured to store vowel mapping information by directions to display the vowel according to the moving direction of the touch event; and
a controller configured to confirm and display a character mapped to a sensed region of a first touch event when the first touch event is sensed through the touch screen in a character input mode, determine whether the first touch event is moved when the first touch event is not released, confirm a moving direction of the first touch event when the touch event is moved, and add a vowel according to the moving direction to the vowel mapping information by directions to display the added vowel mapping information on the display unit.

15. The apparatus of claim 14, wherein the controller is configured to determine whether a second touch event is sensed through the touch screen, determining whether at least one of the first touch event and the second touch event is moved when the second touch event is sensed.

16. The apparatus of claim 15, wherein the controller is configured to cause the display unit to display a vowel according to the moved touch event.

17. The apparatus of claim 15, wherein the controller is configured to determine whether a moving direction of at least one of the first touch event and the second touch event is a diagonal direction to display the vowel.

18. The apparatus of claim 14, wherein the moving direction of the touch event is at least one of an upward direction, a downward direction, a left direction, a right direction, a rotation direction, a horizontal direction, and a vertical direction.

19. The apparatus of claim 14, wherein the controller adds a stroke to a vowel to display the added vowel according to a moving direction of the at least one touch event when a moving direction of the touch event is not the diagonal direction.

20. The apparatus of claim 14, wherein the controller displays a vowel ‘|(i)’ or ‘-(eu)’ when the moving direction is a diagonal direction.
